(19) United States
(12) Patent Application Publication
(10) Pub. No.: US 2024/0070491 A1
(43) Pub. Date: Feb. 29, 2024

(54) SIMULATING AN APPLICATION OF A TREATMENT ON A DEMAND SIDE AND A SUPPLY SIDE ASSOCIATED WITH AN ONLINE SYSTEM

(71) Applicant: Maplebear Inc. (dba Instacart), San Francisco, CA (US)

(72) Inventors: Lanchao Liu, Fremont, CA (US); George Ruan, Saratoga, CA (US); Zhiqiang Wang, San Francisco, CA (US); Xiangdong Liang, Arlington, MA (US); Jagannath Putrevu, Daly City, CA (US); Ganesh Krishnan, San Francisco, CA (US); Ryan Dick, San Francisco, CA (US)

(21) Appl. No.: 17/900,533

(22) Filed: Aug. 31, 2022

(51) Int. Cl. G06N 5/04; G06N 5/02

(52) U.S. Cl. CPC G06N 5/04; G06N 5/022

(57) ABSTRACT

An online system accesses a machine learning model trained to predict behaviors of users of the online system, in which the model is trained based on historical data received by the online system that is associated with the users and demand and supply sides associated with the online system. The online system identifies a treatment for achieving a goal of the online system and simulates application of the treatment on the demand and supply sides based on the historical data and a set of behaviors predicted for the users. Application of the treatment is simulated by replaying the historical data in association with application of the treatment and applying the model to predict the set of behaviors while replaying the data. The online system measures an effect of application of the treatment on the demand and supply sides based on the simulation, in which the effect is associated with the goal.

### BACKGROUND

This disclosure relates generally to testing a treatment on an online system and more specifically to simulating an application of a treatment on a demand side and a supply side associated with an online system.

Online systems often perform A/B tests to compare the effects of different versions of variables or “treatments” on their users, in which the effects are associated with goals of the online systems (e.g., to maximize growth, to minimize costs to users, etc.). To perform an A/B test, each online system user participating in the test is assigned to a control group or a test group and a treatment being tested is applied to the test group, but not to the control group. An effect of an absence of the treatment on the control group is measured to establish a baseline with which an effect of the treatment on the test group is compared, allowing the effect of the treatment to be evaluated while minimizing the effects of other variables. For example, an online system, such as an online concierge system, may perform an A/B test to compare the effects of changing the number of orders included in a batch that shoppers may accept for fulfillment on the rate that customers place orders. In this example, effects of the treatment (e.g., a decreased number of orders included in a batch) and the absence of the treatment (i.e., the original number of orders included in a batch) are measured as the average rates orders are placed by customers in the test group and the control group, respectively, which are then compared to each other.

However, prior to performing an A/B test, it may be difficult to determine whether a treatment or a version of the treatment may have undesirable consequences, especially for online systems operating under a variety of constraints that are testing treatments that may have down-stream effects influenced by several interrelated factors. In the above example, although the average rate orders were placed by customers may have been higher for the test group than the control group, this beneficial effect may be outweighed by detrimental effects of the treatment that were unforeseen, including decreased customer satisfaction and an increased rate at which orders were delivered late. Continuing with the above example, it may have been difficult to anticipate that the average rate at which customers in the test group placed orders would increase to the point that there would be an insufficient number of shoppers to accept the batches for fulfillment in a timely manner. Additionally, in the above example, it also may have been difficult to anticipate that the rate at which shoppers would accept batches for fulfillment would decrease significantly due to a constraint that adjusts a pay rate for shoppers in proportion to the number of orders included in a batch, a longer average distance between warehouses at which orders included in a batch are to be fulfilled, etc. Furthermore, if a treatment has a detrimental effect, by the time this effect is detected, online system users in a test group have already been exposed to the treatment, which may have lasting effects. In the above example, dissatisfied customers in the test group may refrain from placing orders in the future and shoppers in the test group may quit.

### SUMMARY

To identify treatments that are likely to have beneficial effects while ruling out treatments that are likely to have detrimental effects prior to performing A/B tests using the treatments, an online system simulates an application of a treatment on a demand side and a supply side associated with the online system, in accordance with one or more aspects of the disclosure. In this way, simulation can be used to avoid performing A/B testing when a treatment to be tested is likely to have a worse outcome than the control or other treatments. Because from an A/B test can take several weeks to manifest, whereas simulation can reduce the feedback loop from weeks to hours, this also saves significant computing resources and accelerates the evaluation of potential treatments.

In one or more embodiments, an online system accesses a machine learning model trained to predict behaviors of users of the online system, in which the model is trained based on historical data received by the online system and the historical data is associated with the users as well as demand and supply sides associated with the online system. The online system identifies a treatment for achieving a goal of the online system and simulates an application of the treatment on the demand and supply sides associated with the online system based on the historical data and a set of behaviors predicted for the users. Application of the treatment is simulated by replaying the historical data in association with application of the treatment and by applying the machine learning model to predict the set of behaviors while replaying the historical data. The online system then measures an effect of the application of the treatment on the demand and supply sides associated with the online system based on the simulation, in which the effect is associated with the goal of the online system.

### BRIEF DESCRIPTION OF THE DRAWINGS

FIG. 1 is a block diagram of a system environment in which an online system, such as an online concierge system, operates, according to one or more embodiments.

FIG. 2 illustrates an environment of an online system, according to one or more embodiments.

FIG. 3 is a diagram of an online system, according to one or more embodiments.

FIG. 4A is a diagram of a customer mobile application (CMA), according to one or more embodiments.

FIG. 4B is a diagram of a shopper mobile application (SMA), according to one or more embodiments.

FIG. 5 is a flowchart of a method for simulating an application of a treatment on a demand side and a supply side associated with an online system, according to one or more embodiments.

FIG. 6 is a conceptual diagram of a method for simulating an application of a treatment on a demand side and a supply side associated with an online system, according to one or more embodiments.

The figures depict embodiments of the present disclosure for purposes of illustration only. Alternative embodiments of the structures and methods illustrated herein may be employed without departing from the principles, or benefits touted, of the disclosure described herein.

### DETAILED DESCRIPTION

### System Architecture

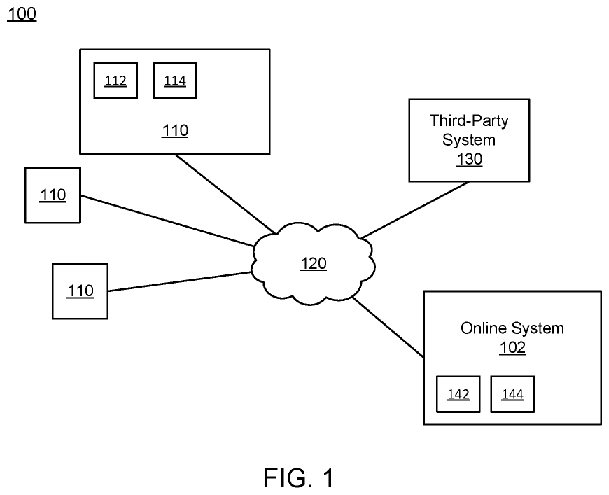

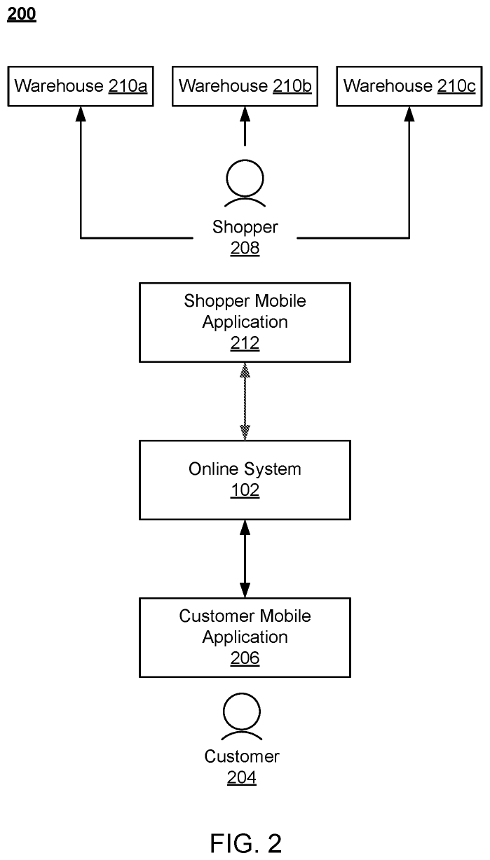

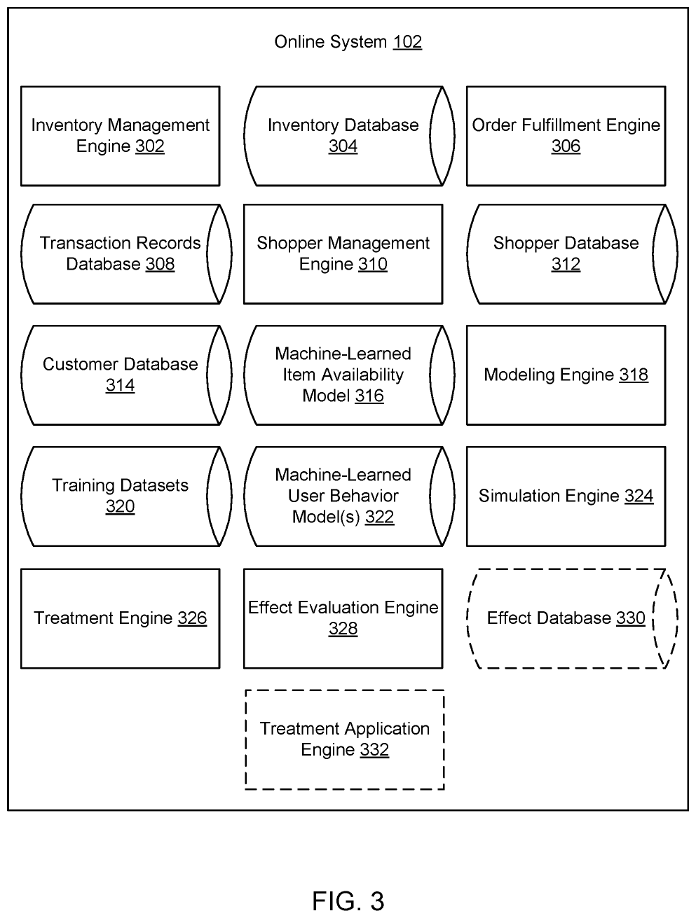

FIG. 1 is a block diagram of a system environment 100 in which an online system (e.g., an online concierge system) 102, as further described below in conjunction with FIGS. 2 and 3, operates. The system environment 100 shown in FIG. 1 comprises one or more client devices 110, a network 120, one or more third-party systems 130, and the online system 102. In alternative configurations, different and/or additional components may be included in the system environment 100. Additionally, in other embodiments, the online system 102 may be configured to retrieve content for display to users and to transmit the content to one or more client devices 110 for display.

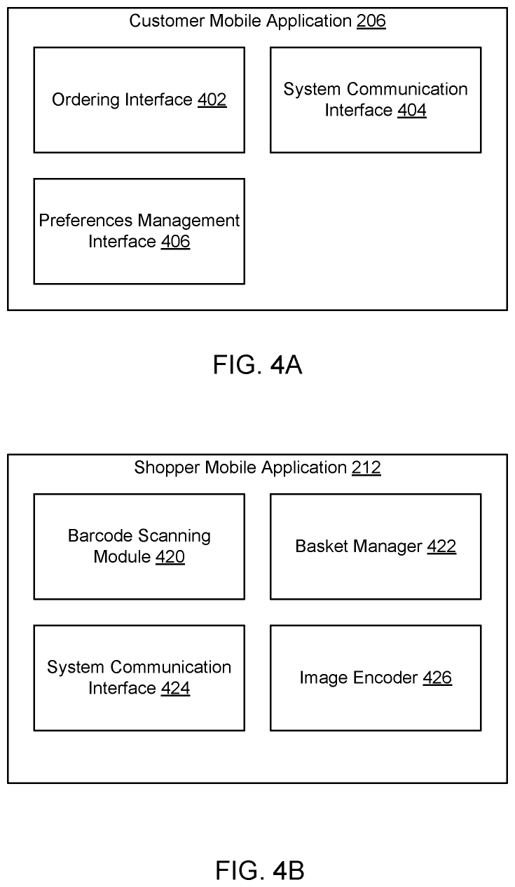

The client devices 110 are one or more computing devices capable of receiving user input as well as transmitting and/or receiving data via the network 120. In one or more embodiments, a client device 110 is a computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via the network 120. In one or more embodiments, a client device 110 executes an application allowing a user of the client device 110 to interact with the online system 102. For example, the client device 110 executes a customer mobile application 206 or a shopper mobile application 212, as further described below in conjunction with FIGS. 4A and 4B, respectively, to enable interaction between the client device 110 and the online system 102. As an additional example, a client device 110 executes a browser application to enable interaction between the client device 110 and the online system 102 via the network 120. In another embodiment, a client device 110 interacts with the online system 102 through an application programming interface (API) running on a native operating system of the client device 110, such as IOS® or ANDROID™.

A client device 110 includes one or more processors 112 configured to control operation of the client device 110 by performing various functions. In various embodiments, a client device 110 includes a memory 114 comprising a non-transitory storage medium on which instructions are encoded. The memory 114 may have instructions encoded thereon that, when executed by the processor 112, cause the processor 112 to perform functions to execute the customer mobile application 206 or the shopper mobile application 212 to provide the functions further described below in conjunction with FIGS. 4A and 4B, respectively.

The client devices 110 are configured to communicate via the network 120, which may comprise any combination of local area and/or wide area networks, using both wired and/or wireless communication systems. In one or more embodiments, the network 120 uses standard communications technologies and/or protocols. For example, the network 120 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third-party systems 130 may be coupled to the network 120 for communicating with the online system 102 or with the client device(s) 110. In one or more embodiments, a third-party system 130 is an application provider communicating information describing applications for execution by a client device 110 or communicating data to client devices 110 for use by an application executing on the client device 110. In other embodiments, a third-party system 130 provides content or other information for presentation via a client device 110. For example, a third-party system 130 stores one or more web pages and transmits the web pages to a client device 110 or to the online system 102. A third-party system 130 may also communicate information to the online system 102, such as advertisements, content, or information about an application provided by the third-party system 130.

The online system 102 includes one or more processors 142 configured to control operation of the online system 102 by performing various functions. In various embodiments, the online system 102 includes a memory 144 comprising a non-transitory storage medium on which instructions are encoded. The memory 144 may have instructions encoded thereon corresponding to the modules further described below in conjunction with FIG. 3 that, when executed by the processor 142, cause the processor 142 to perform the functionality further described below in conjunction with FIGS. 2 and 5-6. For example, the memory 144 has instructions encoded thereon that, when executed by the processor 142, cause the processor 142 to simulate an application of a treatment on a demand side and a supply side associated with the online system 102. Additionally, the online system 102 includes a communication interface configured to connect the online system 102 to one or more networks, such as network 120, or to otherwise communicate with devices (e.g., client devices 110) connected to the network(s).

One or more of a client device 110, a third-party system 130, or the online system 102 may be special-purpose computing devices configured to perform specific functions, as further described below in conjunction with FIGS. 2-6, and may include specific computing components such as processors, memories, communication interfaces, and/or the like.

### System Overview

FIG. 2 illustrates an environment 200 of an online platform, such as an online system 102, according to one or more embodiments. The figures use like reference numerals to identify like elements. A letter after a reference numeral, such as “210a,” indicates that the text refers specifically to the element having that particular reference numeral. A reference numeral in the text that is not followed by a letter, such as “210,” refers to any or all of the elements in the figures bearing that reference numeral. For example, “210” in the text may refer to reference numerals “210a,” “210b,” and/or “210c” in the figures.

The environment 200 includes an online system (e.g., an online concierge system) 102. The online system 102 may be configured to receive orders from one or more customers 204 (only one is shown for the sake of simplicity). An order specifies a list of goods (items or products) to be delivered to a customer 204. An order also specifies a location to which goods are to be delivered, and a time window during which the goods should be delivered. In some embodiments, an order specifies one or more retailers from which goods should be purchased. A customer 204 may use a customer mobile application (CMA) 206, which is configured to communicate with the online system 102, to place an order.

The online system 102 also may be configured to transmit orders received from customers 204 to one or more shoppers 208. A shopper 208 may be a person (e.g., a contractor, an employee, etc.), an entity, or an autonomous device (e.g., a robot) enabled to fulfill orders received by the online system 102. A shopper 208 travels between a warehouse 210 and a delivery location (e.g., a customer's home or office) and may do so by car, truck, bicycle, scooter, foot, or via any other mode of transportation. In some embodiments, a delivery may be partially or fully automated, e.g., using a self-driving car. The environment 200 also includes three warehouses 210a, 210b, and 210c (while only three are shown for the sake of simplicity, the environment 200 may include hundreds of warehouses 210). The warehouses 210 may be physical retailers, such as grocery stores, discount stores, department stores, etc., or non-public warehouses 210 storing items that may be collected and delivered to customers 204. Each shopper 208 fulfills an order received from the online system 102 at one or more warehouses 210, delivers the order to a customer 204, or performs both fulfillment and delivery. In one or more embodiments, shoppers 208 make use of a shopper mobile application 212 which is configured to interact with the online system 102.

FIG. 3 is a diagram of an online system 102, according to one or more embodiments. In various embodiments, the online system 102 may include different or additional modules than those described in conjunction with FIG. 3. Furthermore, in some embodiments, the online system 102 includes fewer modules than those described in conjunction with FIG. 3.

The online system 102 includes an inventory management engine 302, which interacts with inventory systems associated with each warehouse 210. In one or more embodiments, the inventory management engine 302 requests and receives inventory information maintained by a warehouse 210. The inventory of each warehouse 210 is unique and may change over time. The inventory management engine 302 monitors changes in inventory for each participating warehouse 210. The inventory management engine 302 is also configured to store inventory records in an inventory database 304. The inventory database 304 may store information in separate records—one for each participating warehouse 210—or may consolidate or combine inventory information into a unified record. Inventory information includes attributes of items that include both qualitative and quantitative information about the items, including size, color, weight, SKU, serial number, etc. In one or more embodiments, the inventory database 304 also stores purchasing rules associated with each item, if they exist. For example, age-restricted items such as alcohol and tobacco are flagged accordingly in the inventory database 304. Additional inventory information useful for predicting the availability of items may also be stored in the inventory database 304. For example, for each item-warehouse combination (a particular item at a particular warehouse 210), the inventory database 304 may store a time that the item was last found, a time that the item was last not found (e.g., if a shopper 208 looked for the item but could not find it), a rate at which the item is found, and a popularity of the item.

For each item, the inventory database 304 identifies one or more attributes of the item and corresponding values for each attribute of the item. For example, the inventory database 304 includes an entry for each item offered by a warehouse 210, in which an entry for an item includes an item identifier that uniquely identifies the item. The entry includes different fields, with each field corresponding to an attribute of the item. A field of an entry includes a value for an attribute corresponding to the field, allowing the inventory database 304 to maintain values of different attributes for various items.

In various embodiments, the inventory management engine 302 maintains a taxonomy of items offered for purchase by one or more warehouses 210. For example, the inventory management engine 302 receives an item catalog from a warehouse 210 identifying items offered for purchase by the warehouse 210. From the item catalog, the inventory management engine 302 determines a taxonomy of items offered by the warehouse 210, in which different levels of the taxonomy provide different levels of specificity about items included in the levels. In various embodiments, the taxonomy identifies a category and associates one or more specific items with the category. For example, a category identifies “milk,” and the taxonomy associates identifiers of different milk items (e.g., milk offered by different brands, milk having one or more different attributes, etc.) with the category. Thus, the taxonomy maintains associations between a category and specific items offered by the warehouse 210 matching the category. In some embodiments, different levels of the taxonomy identify items with differing levels of specificity based on any suitable attribute or combination of attributes of the items. For example, different levels of the taxonomy specify different combinations of attributes of items, so items in lower levels of the hierarchical taxonomy have a greater number of attributes, corresponding to greater specificity in a category, while items in higher levels of the hierarchical taxonomy have a fewer number of attributes, corresponding to less specificity in a category. In various embodiments, higher levels of the taxonomy include fewer details about items, so greater numbers of items are included in higher levels (e.g., higher levels include a greater number of items satisfying a broader category). Similarly, lower levels of the taxonomy include greater details about items, so fewer numbers of items are included in the lower levels (e.g., lower levels include a fewer number of items satisfying a more specific category). The taxonomy may be received from a warehouse 210 in various embodiments. In other embodiments, the inventory management engine 302 applies a trained classification model to an item catalog received from a warehouse 210 to include different items in levels of the taxonomy, so application of the trained classification model associates specific items with categories corresponding to levels within the taxonomy.

Inventory information provided by the inventory management engine 302 may supplement training datasets 320. Inventory information provided by the inventory management engine 302 may not necessarily include information about the outcome of fulfilling a delivery order associated with the item, whereas the data within the training datasets 320 is structured to include an outcome of fulfilling a delivery order (e.g., if an item in an order was or was not collected).

The online system 102 also includes an order fulfillment engine 306 which is configured to synthesize and display an ordering interface to each customer 204 (for example, via the customer mobile application 206). The order fulfillment engine 306 is also configured to access the inventory database 304 in order to determine which items are available at which warehouse 210. The order fulfillment engine 306 may supplement the item availability information from the inventory database 304 with item availability information predicted by a machine learning item availability model 316. The order fulfillment engine 306 determines a sale price for each item ordered by a customer 204. Prices set by the order fulfillment engine 306 may or may not be identical to in-store prices determined by retailers (which is the price that customers 204 and shoppers 208 would pay at the retail warehouses 210). The order fulfillment engine 306 also facilitates transactions associated with each order. In one or more embodiments, the order fulfillment engine 306 charges a payment instrument associated with a customer 204 when he/she places an order. The order fulfillment engine 306 may transmit payment information to an external payment gateway or payment processor. The order fulfillment engine 306 stores payment and transactional information associated with each order in a transaction records database 308.

In various embodiments, the order fulfillment engine 306 generates and transmits a search interface to a client device 110 of a customer 204 for display via the customer mobile application 206. The order fulfillment engine 306 receives a query comprising one or more terms from a customer 204 and retrieves items satisfying the query, such as items having descriptive information matching at least a portion of the query. In various embodiments, the order fulfillment engine 306 leverages item embeddings for items to retrieve items based on a received query. For example, the order fulfillment engine 306 generates an embedding for a query and determines measures of similarity between the embedding for the query and item embeddings for various items included in the inventory database 304.

In some embodiments, the order fulfillment engine 306 also shares order details with warehouses 210. For example, after successful fulfillment of an order, the order fulfillment engine 306 may transmit a summary of the order to the appropriate warehouses 210. Details of an order may indicate the items purchased, a total value of the items, and in some cases, an identity of a shopper 208 and a customer 204 associated with the order. In one or more embodiments, the order fulfillment engine 306 pushes transaction and/or order details asynchronously to retailer systems. This may be accomplished via the use of webhooks, which enable programmatic or system-driven transmission of information between web applications. In another embodiment, retailer systems may be configured to periodically poll the order fulfillment engine 306, which provides details of all orders which have been processed since the last request.

The order fulfillment engine 306 may interact with a shopper management engine 310, which manages communication with and utilization of shoppers 208. In one or more embodiments, the shopper management engine 310 receives a new order from the order fulfillment engine 306. The shopper management engine 310 identifies the appropriate warehouse 210 to fulfill the order based on one or more parameters, such as a probability of item availability determined by the machine learning item availability model 316, the contents of the order, the inventory of the warehouses 210, and the proximity of the warehouses 210 to the delivery location. The shopper management engine 310 then identifies one or more appropriate shoppers 208 to fulfill the order based on one or more parameters, such as the shoppers' proximity to the appropriate warehouse 210 (and/or to the customer 204), his/her familiarity level with that particular warehouse 210, etc. Additionally, the shopper management engine 310 accesses a shopper database 312 which stores information describing each shopper 208, such as his/her name, gender, rating, previous shopping history, etc.

As part of fulfilling an order, the order fulfillment engine 306 and/or shopper management engine 310 may access a customer database 314, which stores information describing each customer 204. This information may include each customer's name, address, gender, shopping preferences, favorite items, stored payment instruments, etc.

In various embodiments, the order fulfillment engine 306 determines whether to delay display of a received order to shoppers 208 for fulfillment by a time interval. In response to determining to delay display of the received order by a time interval, the order fulfilment engine 306 evaluates subsequent orders received during the time interval for inclusion in one or more batches that also include the received order. After the time interval, the order fulfillment engine 306 displays the order to one or more shoppers 208 via the shopper mobile application 212; if the order fulfillment engine 306 generated one or more batches including the received order and one or more subsequent orders received during the time interval, the batch(es) is/are also displayed to one or more shoppers 208 via the shopper mobile application 212.

### Machine Learning Models

The online system 102 further includes the machine learning item availability model 316, a modeling engine 318, the training datasets 320, and one or more machine learning user behavior models 322. The modeling engine 318 uses the training datasets 320 to generate the machine learning item availability model 316 and the machine learning user behavior model(s) 322. The machine learning item availability model 316 and/or the machine learning user behavior model(s) 322 may learn from the training datasets 320, rather than follow only explicitly programmed instructions. A simulation engine 324, which is further described below, may apply the machine learning user behavior model(s) 322 to predict behaviors of users of the online system 102. A single machine learning user behavior model 322 may be used to predict any number of behaviors for any number of users of the online system 102. The machine learning user behavior model(s) 322 may be updated and adapted to receive any information that the modeling engine 318 identifies as an indicator of user behavior following retraining with new training datasets 320. Furthermore, a machine learning user behavior model 322 may be any machine learning model (e.g., a neural network, a boosted tree, a gradient-boosted tree, or a random forest model). The inventory management engine 302, order fulfillment engine 306, and/or shopper management engine 310 may use the machine learning item availability model 316 to determine a probability that an item is available at a warehouse 210. The machine learning item availability model 316 may be used to predict item availability for items being displayed to or selected by a customer 204 or included in received delivery orders. A single machine learning item availability model 316 is used to predict the availability of any number of items.

The machine learning item availability model 316 may be configured to receive, as inputs, information about an item, a warehouse 210 for collecting the item, and a time for collecting the item. The machine learning item availability model 316 may be adapted to receive any information that the modeling engine 318 identifies as an indicator of item availability. At a minimum, the machine learning item availability model 316 receives information about an item-warehouse pair, such as an item in a delivery order and a warehouse 210 at which the order may be fulfilled. Items stored in the inventory database 304 may be identified by item identifiers. As described above, various characteristics, some of which are specific to a warehouse 210 (e.g., a time that an item was last found in the warehouse 210, a time that the item was last not found in the warehouse 210, a rate at which the item is found, a popularity of the item, etc.) may be stored for each item in the inventory database 304. Similarly, each warehouse 210 may be identified by a warehouse identifier and stored in a warehouse database along with information about the warehouse 210. A particular item at a particular warehouse 210 may be identified using an item identifier and a warehouse identifier. In other embodiments, the item identifier refers to a particular item at a particular warehouse 210, so that the same item at two different warehouses 210 is associated with two different identifiers. For convenience, both of these options to identify an item at a warehouse 210 are referred to herein as an “item-warehouse pair.” Based on the identifier(s), the online system 102 may extract information about the item and/or warehouse 210 from the inventory database 304 and/or warehouse database and provide this extracted information as inputs to the machine learning item availability model 316.

The machine learning item availability model 316 contains a set of functions generated by the modeling engine 318 from the training datasets 320 that relate an item, a warehouse 210, timing information, and/or any other relevant inputs, to a probability that the item is available at the warehouse 210. Thus, for a given item-warehouse pair, the machine learning item availability model 316 outputs a probability that the item is available at the warehouse 210. The machine learning item availability model 316 constructs a relationship between the item-warehouse pair, the timing information, and/or any other inputs and the probability of availability (also referred to as “availability”) that is generic enough to apply to any number of different item-warehouse pairs. In some embodiments, the probability output by the machine learning item availability model 316 includes a confidence score. The confidence score may be the error or uncertainty score of the probability of availability and may be calculated using any standard statistical error measurement. In some embodiments, the confidence score is based in part on whether the item-warehouse pair availability prediction was accurate for previous delivery orders (e.g., if an item was predicted to be available at a warehouse 210 and was not found by a shopper 208 or was predicted to be unavailable but was found by the shopper 208). In various embodiments, the confidence score is based in part on the age of the data for the item (e.g., if availability information has been received within the past hour or the past day). The set of functions of the machine learning item availability model 316 may be updated and adapted following retraining with new training datasets 320. The machine learning item availability model 316 may be any machine learning model, such as a neural network, a boosted tree, a gradient-boosted tree, or a random forest model. In some embodiments, the machine learning item availability model 316 is generated from the XGBoost algorithm. The probability of availability of an item generated by the machine learning item availability model 316 may be used to determine instructions delivered to a customer 204 and/or shopper 208, as described in further detail below.

The training datasets 320 relate a variety of different factors to known item availabilities from the outcomes of previous delivery orders (e.g., if an item was previously found or previously unavailable). The training datasets 320 include items included in previous delivery orders, whether the items in the previous delivery orders were collected, warehouses 210 associated with the previous delivery orders, and a variety of characteristics associated with each of the items, which may be obtained from the inventory database 304. Each piece of data in the training datasets 320 includes an outcome of a previous delivery order (e.g., whether an item was collected). Item characteristics may be determined by the machine learning item availability model 316 to be statistically significant factors predictive of an item's availability. Item characteristics that are predictors of availability may be different for different items. For example, an item type factor might be the best predictor of availability for dairy items, whereas a time of day may be the best predictive factor of availability for vegetables. For each item, the machine learning item availability model 316 may weight these factors differently, in which the weights are a result of a “learning” or a training process on the training datasets 320. The training datasets 320 are very large datasets taken across a wide cross section of warehouses 210, shoppers 208, items, delivery orders, times, and item characteristics. The training datasets 320 are large enough to provide a mapping from an item in an order to a probability that the item is available at a warehouse 210. In addition to previous delivery orders, the training datasets 320 may be supplemented by inventory information provided by the inventory management engine 302. In some embodiments, the training datasets 320 are historical delivery order information used to train the machine learning item availability model 316, whereas the inventory information stored in the inventory database 304 includes factors input into the machine learning item availability model 316 to determine an item availability for an item in a newly received delivery order. In various embodiments, the modeling engine 318 may evaluate the training datasets 320 to compare a single item's availability across multiple warehouses 210 to determine if an item is chronically unavailable, which may indicate that the item is no longer manufactured. The modeling engine 318 may query a warehouse 210 through the inventory management engine 302 for updated item information about any such items.

The training datasets 320 also may include additional historical data that is associated with users of the online system 102 as well as a demand side and a supply side associated with the online system 102. The historical data may be received from other components of the online system 102, such as the order fulfillment engine 306, the shopper management engine 310, etc., and/or components of the CMA 206 and the SMA 212, as further described below in conjunction with FIGS. 4A and 4B, which may receive the data from various sources (e.g., users of the online system 102, warehouses 210, retailers, etc.). The historical data may relate a variety of different factors to interactions with the online system 102 by its users. For example, historical data associated with the demand side associated with the online system 102 may describe various interactions of a customer 204 with the online system 102 (e.g., via the CMA 206), such as a time at which the customer 204 accessed an ordering interface, whether the customer 204 placed an order, any promotions or offers presented to the customer 204, etc. In the above example, the historical data also may describe items the customer 204 browsed during the session, an amount of time the customer 204 browsed each item, an estimated delivery time, a size of a delivery window, and/or a delivery cost presented to the customer 204, whether the customer 204 included special instructions for an order, whether the customer 204 later reported a problem with an order, etc. As an additional example, historical data associated with the supply side associated with the online system 102 may describe various interactions of a shopper 208 with the online system 102 (e.g., via the SMA 212), such as a time at which an order or batch was transmitted to the shopper 208, whether the shopper 208 accepted or rejected the order/batch for fulfillment, a location associated with the shopper 208 when the shopper 208 accepted/rejected the order/batch for fulfillment, etc. In the above example, the historical data also may describe one or more warehouses 210 at which the order/batch was to be fulfilled, an amount of time elapsed between transmission and acceptance/rejection of the order/batch by the shopper 208, one or more delivery locations associated with the order/batch, one or more tip amounts associated with the order/batch, special instructions associated with the order/batch, information identifying the order/batch, etc.

The machine learning user behavior model(s) 322 may be trained by the modeling engine 318 based on historical data, in which the historical data is associated with users of the online system 102 as well as a demand side and a supply side associated with the online system 102 included in the training datasets 320. In some embodiments, the machine learning user behavior model(s) 322 may be trained based on various features associated with the users included among the historical data. For example, for online system users who are shoppers 208, the machine learning user behavior model(s) 322 may be trained based on features including whether the shoppers 208 accepted or rejected orders or batches for fulfillment, dates, times of day, and/or days of the week during which they accepted/rejected orders/batches for fulfillment, pay rates and/or tip amounts for which they accepted/rejected orders/batches for fulfillment, etc. As an additional example, for online system users who are customers 204, the machine learning user behavior model(s) 322 may be trained based on features including whether the customers 204 placed orders, dates, times of day, and/or days of the week during which they placed orders, etc. Features that are predictors of user behavior may be different for different users. For example, an estimated delivery time and a size of a delivery window may be the best predictors of whether customers 204 in urban areas are likely to place orders, whereas a delivery cost may be the best predictor of whether customers 204 in suburban areas are likely to place orders. For each online system user, the machine learning user behavior model(s) 322 may weight these features differently, in which the weights are a result of a “learning” or a training process on the training datasets 320. Once trained, the machine learning user behavior model(s) 322 may receive inputs corresponding to features associated with online system users used to train the machine learning user behavior model(s) 322, as further described below, and output predicted behaviors of the online system users based on the inputs.

In some embodiments, behaviors of users of the online system 102 predicted by the machine learning user behavior model(s) 322 may be associated with a supply side and/or a demand side associated with the online system 102. Examples of user behaviors associated with the supply side associated with the online system 102 that may be predicted by the machine learning user behavior model(s) 322 include whether a shopper 208 will accept an order/batch for fulfillment for a given time of day, day of the week, pay rate, tip amount, estimated delivery time, delivery window, warehouse 210 at which the order/batch is to be fulfilled, delivery location associated with the order/batch, order/batch size, etc. Additional examples of user behaviors associated with the supply side associated with the online system 102 that may be predicted by the machine learning user behavior model(s) 322 include whether a shopper 208 will fulfill an order by an estimated delivery time and/or within a delivery window, whether a shopper 208 will take a particular route to fulfill an order/batch, whether a shopper 208 will fulfill an order accurately, etc. Examples of user behaviors associated with the demand side associated with the online system 102 that may be predicted by the machine learning user behavior model(s) 322 include whether a customer 204 will place an order for a given time of day, day of the week, delivery cost, estimated delivery time, delivery window size, etc. Additional examples of user behaviors associated with the demand side associated with the online system 102 that may be predicted by the machine learning user behavior model(s) 322 include whether a customer 204 will place an order that includes at least a threshold number of items and/or a certain type of item, whether a customer 204 will place an order with a particular retailer, whether a customer 204 will include special instructions in an order, etc.

In some embodiments, the machine learning user behavior model(s) 322 may predict behaviors of online system users based on one or more conversion and/or cost curves generated by the machine learning user behavior model(s) 322 from the training datasets 320. A conversion curve may describe a likelihood that one or more users of the online system 102 will perform an action corresponding to a conversion given one or more variables (e.g., a delivery cost, an estimated delivery time, a delivery window size, a time of day, a day of the week, etc.). Similarly, a cost curve may describe a cost of fulfilling an order given one or more variables (e.g., whether the order is included in a batch, a number of additional orders included in a batch in which the order is included, a retailer with which the order was placed, a number of warehouses 210 at which the order may be fulfilled, a delivery location associated with the order, etc.). In some embodiments, the cost of fulfilling an order described by a cost curve may correspond to a delivery cost that may be charged to a customer 204, while in other embodiments, the cost of fulfilling an order may correspond to and/or include other costs associated with fulfilling an order (e.g., overhead costs incurred by the online system 102). A conversion curve and/or a cost curve may be plotted for multiple dimensions, in which each dimension corresponds to a different variable.

The machine learning user behavior model(s) 322 may generate different conversion and/or cost curves for different groups of online system users (e.g., groups of users that have at least a threshold measure of similarity to each other). For example, the machine learning user behavior model(s) 322 may generate different conversion curves and cost curves for online system users associated with different geographic areas. As an additional example, the machine learning user behavior model(s) 322 may generate a conversion curve for online system users whose likelihood of placing an order is highly dependent on a size of a delivery window, but only slightly dependent on an amount of a delivery cost. In the above example, the machine learning user behavior model(s) 322 may generate a different conversion curve for online system users whose likelihood of placing an order is highly dependent on an amount of a delivery cost, but only slightly dependent on a size of a delivery window. In embodiments in which the online system 102 includes multiple machine learning user behavior models 322, different machine learning user behavior models 322 may generate different conversion and/or cost curves.

In some embodiments, a prediction output by the machine learning user behavior model(s) 322 includes a confidence score. A confidence score may be an error or uncertainty score of a predicted user behavior and may be calculated using any standard statistical error measurement. In some embodiments, confidence scores are based in part on whether predictions were accurate for previous types of user behaviors predicted by the machine learning user behavior model(s) 322 (e.g., when simulating an absence of an application of a treatment, as further described below), such that types of predicted behaviors that were more accurate have higher confidence scores than types of predicted behaviors that were less accurate. In various embodiments, confidence scores associated with predicted user behaviors are based in part on the age of the historical data used to train the machine learning user behavior model(s) 322 that made the predictions, such that the confidence scores are inversely proportional to the age of the historical data.

In embodiments in which the online system 102 includes multiple machine learning user behavior models 322, different machine learning user behavior models 322 may predict different types of behaviors and/or behaviors for different users of the online system 102. For example, one machine learning user behavior model 322 may predict a likelihood that a shopper 208 will accept an order or a batch of orders for fulfillment while another machine learning user behavior model 322 may predict an amount of time the shopper 208 will take to fulfill the order/batch. As an additional example, one machine learning user behavior model 322 may predict user behaviors for online system users in one geographic area while another machine learning user behavior model 322 may predict user behaviors for online system users in another geographic area.

In embodiments in which the online system 102 includes multiple machine learning user behavior models 322, the output of one machine learning user behavior model 322 may be used by the simulation engine 324 (described below) to determine an input for another machine learning user behavior model 322 (e.g., when performing branched simulations or simulations for discrete events, as described below). For example, if a first machine learning user behavior model 322 outputs predictions about whether various shoppers 208 will accept orders/batches for fulfillment and confidence scores associated with the predictions, the simulation engine 324 may provide the predictions as inputs to a second machine learning user behavior model 322. In this example, the second machine learning user behavior model 322 then outputs predictions about whether the shoppers 208 will fulfill the orders/batches by their corresponding estimated delivery times and/or within their delivery windows and confidence scores associated with the predictions.

### Machine Learning Factors

The training datasets 320 include times associated with previous delivery orders. In some embodiments, the training datasets 320 include a time of day at which each previous delivery order was placed. Item availability may be impacted by time of day since items that are otherwise regularly stocked by warehouses 210 may become unavailable during high-volume shopping times. In addition, item availability may be affected by restocking schedules. For example, if a warehouse 210 mainly restocks items at night, item availability at the warehouse 210 will tend to decrease over the course of the day. Additionally, or alternatively, the training datasets 320 include a day of the week that previous delivery orders were placed. The day of the week may impact item availability since warehouses 210 may have reduced item inventory on popular shopping days and restocking shipments may be received on particular days. In some embodiments, the training datasets 320 include a time interval since an item was previously collected for a previous delivery order. If an item has recently been collected at a warehouse 210, this may increase the probability that it is still available. If a long interval of time has elapsed since an item has been collected, this may indicate that the probability that the item is available for subsequent orders is low or uncertain. In some embodiments, the training datasets 320 include a time interval since an item in a previous delivery order was not found. If a short interval of time has elapsed since an item was not found, this may indicate that there is a low probability that the item will be available for subsequent delivery orders. Conversely, if a long interval of time has elapsed since an item was not found, this may indicate that the item may have been restocked and will be available for subsequent delivery orders. In some embodiments, the training datasets 320 may also include a rate at which an item is typically found by a shopper 208 at a warehouse 210, a number of days since inventory information about the item was last received from the inventory management engine 302, a number of times the item was not found during a previous week, or any number of additional rate-related or time-related information. Relationships between this rate-related and/or time-related information and item availability are determined by the modeling engine 318, which trains a machine learning model with the training datasets 320, producing the machine learning item availability model 316.

The training datasets 320 include item characteristics. In some embodiments, the item characteristics include a department associated with an item. For example, if an item is yogurt, it is associated with a dairy department. Examples of departments include bakery, beverage, nonfood, pharmacy, produce, floral, deli, prepared foods, meat, seafood, dairy, or any other categorization of items used by a warehouse 210. A department associated with an item may affect item availability since different departments have different item turnover rates and inventory levels. In some embodiments, the item characteristics include an aisle of a warehouse 210 associated with an item. The aisle of the warehouse 210 may affect item availability since different aisles of a warehouse 210 may be re-stocked more frequently than others. Additionally, or alternatively, the item characteristics may include an item popularity score. The item popularity score for an item may be proportional to the number of delivery orders received that include the item. An alternative or additional item popularity score may be provided by a retailer through the inventory management engine 302. In some embodiments, the item characteristics include a product type associated with an item. For example, if an item is a particular brand of a product, the product type will be a generic description of the product type, such as “milk” or “eggs.” The product type may affect item availability since certain product types may have higher turnover and re-stocking rates than others or may have larger inventories in the warehouses 210. In some embodiments, the item characteristics may include a number of times a shopper 208 was instructed to keep looking for an item after he or she was initially unable to find the item, a total number of delivery orders received for an item, whether or not an item is organic, vegan, gluten free, or any other characteristics associated with an item. The relationships between item characteristics and item availability are determined by the modeling engine 318, which trains a machine learning model with the training datasets 320, producing the machine learning item availability model 316.

The training datasets 320 may include additional item characteristics that affect item availability and may therefore be used to build the machine learning item availability model 316 relating a delivery order including an item to the item's predicted availability. The training datasets 320 may be periodically updated with recent delivery orders. The training datasets 320 may be updated with item availability information provided directly from shoppers 208. Following updating of the training datasets 320, the modeling engine 318 may retrain a model with the updated training datasets 320 and produce a new machine learning item availability model 316.

As described above, the training datasets 320 also include features associated with users of the online system 102 included among historical data associated with a supply side and/or a demand side associated with the online system 102. In some embodiments, features associated with online system users associated with a supply side associated with the online system 102 may include any information describing interactions by shoppers 208 with the online system 102. Examples of such features may include whether a shopper 208 accepted or rejected an order or batch for fulfillment, their location when they accepted/rejected the order/batch, a date and time when they accepted/rejected the order/batch, a type of client device 110 used to accept/reject the order/batch, etc. Additional examples of such features may include a pay rate, one or more tip amounts, one or more estimated delivery times, one or more delivery windows, one or more warehouses 210 at which the order/batch was to be fulfilled, and/or one or more delivery locations associated with the order/batch. If a shopper 208 accepts an order/batch for fulfillment, additional examples of features may include an amount of time the shopper 208 took to fulfill the order/batch, a route the shopper 208 took to fulfill the order/batch, whether the order/batch was fulfilled accurately, etc. In various embodiments, features associated with online system users associated with the demand side associated with the online system 102 may include any information describing interactions by customers 204 with the online system 102. Examples of such features may include whether a customer 204 placed an order, a date and time when they accessed an ordering interface, a delivery cost, an estimated delivery time, and a size of a delivery window shown to the customer 204 via the ordering interface, a type of client device 110 used to access the ordering interface, etc. If a customer 204 places an order, additional examples of features may include a number of items included in the order, a retailer with which the order was placed, special instructions included in the order, any discounts or offers applied to the order, a total amount paid for the order, an amount of a tip provided for the order (if any), a payment instrument used to pay for the order, etc. If a customer 204 does not place an order, additional examples of features may include a number of items included in the customer's cart, a retailer associated with the cart, any discounts or offers that may have been applied to the order, a subtotal for the order, etc.

In some embodiments, features associated with online system users associated with the demand side and the supply side associated with the online system 102 included among the training datasets 320 may overlap with information stored in various databases in the online system 102. For example, features associated with online system users included among the training datasets 320 may overlap with information stored in the shopper database 312 associated with each shopper 208 (e.g., the shopper's name, gender, rating, previous shopping history, familiarity levels with various warehouses 210, etc.). As an additional example, features associated with online system users included among the training datasets 320 may overlap with information stored in the customer database 314 associated with each customer 204 (e.g., the customer's name, address, gender, shopping preferences, favorite items, stored payment instruments, favorite or preferred warehouses 210, preferred delivery times, special instructions for delivery, etc.).

### Simulation Components

The online system 102 further includes the simulation engine 324. The simulation engine 324 accesses the machine learning user behavior model(s) 322 trained to predict behaviors of users of the online system 102. As described above, the machine learning user behavior model(s) 322 may be trained by the modeling engine 318 once the online system 102 receives historical data associated with online system users, in which the historical data is associated with the demand side and the supply side associated with the online system 102. As also described above, the historical data is received via various components of the online system 102, the CMA 206, and/or the SMA 212, and stored in the training datasets 320, which the modeling engine 318 then uses to train the machine learning user behavior model(s) 322.

The simulation engine 324 also simulates an application of a treatment on the demand side and the supply side associated with the online system 102. The simulation engine 324 may do so based on historical data associated with online system users and a set of behaviors predicted for the users, in which the historical data is associated with the demand side and the supply side associated with the online system 102. A treatment may correspond to any potential change associated with the online system 102, such as a change to a delivery cost, an estimated delivery time, a size of a delivery window, an algorithm for batching orders, a pay rate, accepted payment instruments, default tip amounts, an algorithm for generating routes for fulfilling orders/batches, a reward/loyalty club membership, or any other suitable change. To simulate an application of a treatment, the simulation engine 324 replays the historical data in association with the application of the treatment and applies the machine learning user behavior model(s) 322 to predict behaviors of users of the online system 102 while replaying the historical data in association with the application of the treatment. In various embodiments, the simulation engine 324 also may simulate an application of a treatment on the demand side and the supply side associated with the online system 102 based on current data associated with online system users and a set of behaviors predicted for the users, in which the current data is associated with the demand side and the supply side associated with the online system 102. In such embodiments, the simulation engine 324 may do so by applying the treatment to the current data as the data is received via various components of the online system 102, the CMA 206, and/or the SMA 212 and applying the machine learning user behavior model(s) 322 to predict behaviors of users of the online system 102 while applying the treatment to the current data.

The simulation engine 324 may simulate an application of a treatment on the demand side and the supply side associated with the online system 102 for a particular population of users of the online system 102 (e.g., users in a particular geographic location) for a particular time period, etc. To do so, the simulation engine 324 may replay the historical data (or play the current data, in various embodiments) for the corresponding population, time period, etc. while applying the treatment and apply the machine learning user behavior model(s) 322 to predict behaviors of users of the online system 102 while replaying the historical data in association with application of the treatment. For example, if a treatment corresponds to a larger delivery window, the simulation engine 324 may apply the treatment while replaying the historical data for a time period of two months, such that the simulation engine 324 simulates an environment in which the larger delivery window was shown to customers 204 and shoppers 208 who interacted with the online system 102 during the two months. Continuing with this example, the simulation engine 324 applies the machine learning user behavior model(s) 322 to predict a set of behaviors of the users of the online system 102, such as whether the customers 204 would have placed orders during the two months if they were shown the larger delivery window. In the above example, the machine learning user behavior model(s) 322 also may predict another set of behaviors of the users of the online system 102, such as whether the shoppers 208 would have accepted orders/batches for fulfillment based on orders that the machine learning user behavior model(s) 322 predicted the customers 204 would have placed if the shoppers 208 were shown the larger delivery window. In this example, inputs to the machine learning user behavior model(s) 322 may include information identifying the customers 204 and shoppers 208, the larger delivery window, the two-month time period, information included among the replayed historical data (e.g., delivery costs and estimated delivery times shown to the customers 204, warehouses 210 at which the orders were fulfilled, pay rates, etc.), or any other suitable features. In the above example, one or more of the predictions also may be associated with a confidence score indicating the error or uncertainty score of the predicted user behavior. Furthermore, in this example, the application of the treatment may have a measurable effect, such as an effect on a rate at which orders are delivered on time, as further described below. In some embodiments, the simulation engine 324 may simulate an application of multiple treatments (e.g., changes to an estimated delivery time and a delivery window) and/or multiple versions of a treatment (e.g., delivery windows that are 60 minutes, 75 minutes, 90 minutes, etc.).

In some embodiments, the simulation engine 324 also may apply various constraints, heuristics, and/or policies when replaying historical data (or when playing current data, in various embodiments) in association with application of a treatment. Constraints, heuristics, and/or policies applied by the simulation engine 324 may be associated with various regulations, a size of a delivery window, an estimated delivery time, a delivery cost, a pay rate, a conversion rate, a probability that orders are batched, a probability that orders/batches are accepted for fulfillment by shoppers 208, a probability that orders are delivered late, a retention rate of customers 204 and/or shoppers 208, etc. Examples of constraints include a maximum rate at which orders may be delivered late (e.g., after their estimated delivery times and/or outside their delivery windows), a maximum estimated delivery time after an order is placed, a minimum and/or maximum pay rate, a minimum and/or maximum delivery cost, membership requirements associated with shoppers 208 fulfilling orders with certain retailers, maximum cargo spaces associated with shoppers 208, etc. Examples of heuristics include an algorithm for batching orders (e.g., based on when they are received, based on a maximum number of orders included in a batch, etc.) and an algorithm for generating routes for fulfilling orders/batches (e.g., based on travel times, tolls, warehouse 210 and delivery locations, items included in each order, etc.). Examples of policies include a maximum number of hours a shopper 208 may work per day, a minimum age of a shopper 208 allowed to fulfill orders that include certain types of items (e.g., alcohol and tobacco), etc. For example, if multiple versions of a treatment correspond to different sizes of delivery windows that are 30 minutes apart, the simulation engine 324 may replay historical data in association with application of each version of the treatment and a constraint corresponding to a maximum delivery window size of three hours. In the above example, the simulation engine 324 also may replay the historical data in association with application of a policy corresponding to a minimum age of a shopper 208 allowed to fulfill orders that include alcohol and tobacco and a heuristic corresponding to an algorithm for batching orders based on when orders are received.

The simulation engine 324 may simulate an application of a treatment on the demand side and the supply side associated with the online system 102 at various levels. In various embodiments, the simulation engine 324 may simulate an application of a treatment on the demand side and the supply side associated with the online system 102 in aggregate. For example, the simulation engine 324 may simulate an application of a treatment on the demand side and the supply side associated with the online system 102 for all users of the online system 102 who interacted with the online system 102 within a time period associated with historical data that is replayed by the simulation engine 324, such that the simulation engine 324 may not account for the order in which each event occurred based on the historical data. In some embodiments, the simulation engine 324 may simulate an application of a treatment on the demand side and the supply side associated with the online system 102 by performing branched simulations. For example, the simulation engine 324 may simulate an application of a treatment on the demand side and the supply side associated with the online system 102 for users of the online system 102 who interacted with the online system 102 within each hour of a time period associated with historical data that is replayed by the simulation engine 324. In this example, the outcome of the simulation for each hour (e.g., orders placed, orders/batches accepted, etc.) serves as the seed for the simulation of the following hour until the historical data for the entire time period is replayed in association with application of the treatment. In various embodiments, the simulation engine 324 may simulate an application of a treatment on the demand side and the supply side associated with the online system 102 for discrete events. For example, the simulation engine 324 may simulate an application of a treatment on the demand side and the supply side associated with the online system 102 for each event within a time period associated with historical data that is replayed by the simulation engine 324. In this example, the outcome of the simulation for each event (e.g., whether a particular customer 204 places an order, whether a particular shopper 208 accepts an order/batch for fulfillment, etc.) serves as the seed for the simulation of the following event until the historical data for the entire time period is replayed in association with application of the treatment.

In some embodiments, the simulation engine 324 also may simulate an absence of an application of a treatment on the demand side and the supply side associated with the online system 102. The simulation engine 324 may do so based on historical data associated with online system users and a set of behaviors predicted for the users, in which the historical data is associated with the demand side and the supply side associated with the online system 102. To simulate an absence of an application of a treatment, the simulation engine 324 replays the historical data and applies the machine learning user behavior model(s) 322 to predict behaviors of users of the online system 102 while replaying the historical data. In various embodiments, the simulation engine 324 also may simulate an absence of an application of a treatment on the demand side and the supply side associated with the online system 102 based on current data associated with online system users and a set of behaviors predicted for the users, in which the current data is associated with the demand side and the supply side associated with the online system 102. In such embodiments, the simulation engine 324 may do so by playing the current data as it is received via various components of the online system 102, the CMA 206, and/or the SMA 212 and applying the machine learning user behavior model(s) 322 to predict behaviors of users of the online system 102 while playing the current data.

The simulation engine 324 may simulate an absence of an application of a treatment on the demand side and the supply side associated with the online system 102 for a particular population of users of the online system 102 (e.g., users in a particular geographic location) for a particular time period, etc. To do so, the simulation engine 324 may replay the historical data (or play the current data, in various embodiments) for the corresponding population, time period, etc. and apply the machine learning user behavior model(s) 322 to predict behaviors of users of the online system 102 while replaying the historical data. For example, if a treatment corresponds to a larger delivery window, the simulation engine 324 may not apply the treatment while replaying the historical data for a time period of two months, such that the simulation engine 324 simulates an environment in which the original delivery window was shown to customers 204 and shoppers 208 who interacted with the online system 102 during the two months. Continuing with this example, the simulation engine 324 applies the machine learning user behavior model(s) 322 to predict a set of behaviors of the users of the online system 102, such as whether the customers 204 would have placed orders during the two months if they were shown the original delivery window. In the above example, the machine learning user behavior model(s) 322 also may predict another set of behaviors of the users of the online system 102, such as whether the shoppers 208 would have accepted orders/batches for fulfillment based on orders that the machine learning user behavior model(s) 322 predicted the customers 204 would have placed if the shoppers 208 were shown the original delivery window. In this example, inputs to the machine learning user behavior model(s) 322 may include information identifying the customers 204 and shoppers 208, the original delivery window, the two-month time period, information included among the replayed historical data (e.g., delivery costs and estimated delivery times shown to the customers 204, warehouses 210 at which the orders were fulfilled, pay rates, etc.), or any other suitable features. In the above example, one or more of the predictions also may be associated with a confidence score indicating the error or uncertainty score of the predicted user behavior. Furthermore, in this example, the absence of the application of the treatment may have a measurable effect, such as an effect on a rate at which orders are delivered on time, as further described below. In some embodiments, the simulation engine 324 may simulate an absence of an application of multiple treatments (e.g., changes to an estimated delivery time and a delivery window) and/or an absence of an application of multiple versions of a treatment (e.g., delivery windows that are 60 minutes, 75 minutes, 90 minutes, etc.).

In embodiments in which the simulation engine 324 simulates an absence of an application of a treatment on the demand side and the supply side associated with the online system 102, the simulation engine 324 may do so in a manner analogous to that described above in conjunction with simulating the application of the treatment. In such embodiments, when simulating an absence of an application of a treatment on the demand side and the supply side associated with the online system 102, the simulation engine 324 also may apply various constraints, heuristics, and/or policies when replaying the historical data (or when playing current data, in various embodiments). Furthermore, the simulation engine 324 also may simulate the absence of the application of the treatment on the demand side and the supply side associated with the online system 102 at various levels (e.g., in aggregate, by performing branched simulations, for discrete events, etc.).

The online system 102 further includes a treatment engine 326. The treatment engine 326 identifies treatments for achieving one or more goals of the online system 102. Goals of the online system 102 may include maximizing growth, minimizing cost to its users, or any other suitable goal. As described above, a treatment may correspond to any potential change associated with the online system 102. For example, a treatment may correspond to a larger or smaller delivery window, a longer or shorter estimated delivery time from a time when an order is placed, a higher or lower delivery cost, a higher or lower pay rate, or a higher or lower default tip amount. In some embodiments, the treatment engine 326 may identify multiple treatments. For example, the treatment engine 326 may identify multiple treatments, such as a combination of a higher delivery cost, a smaller delivery window, and a shorter estimated delivery time from a time when an order is placed. In various embodiments, the treatment engine 326 also or alternatively may identify multiple versions of a treatment. For example, the treatment engine 326 may identify multiple versions of a treatment, such as different versions of an algorithm that each includes a different number of orders together in a batch.

In various embodiments, the treatment engine 326 also may adjust a treatment. In some embodiments, the treatment engine 326 may do so based on information received from the effect evaluation engine 328 (described below). Information the treatment engine 326 receives from the effect evaluation engine 328 may indicate whether an effect of an application of a treatment is at least a threshold effect. For example, suppose that a treatment corresponds to an increased pay rate for shoppers 208 and that the treatment engine 326 receives information from the effect evaluation engine 328 indicating that its application had an effect corresponding to a decrease in a rate at which orders were delivered late (i.e., after an estimated delivery time and/or outside a delivery window) that is less than a threshold decrease in the rate. In this example, the treatment engine 326 may adjust the treatment by increasing the pay rate for shoppers 208 to an even higher rate. However, in the above example, if the information received by the treatment engine 326 indicates that the treatment had an effect corresponding to a decrease in the rate at which orders were delivered late that is at least the threshold decrease in the rate, the treatment engine 326 either may not adjust the treatment or it may adjust the treatment by changing the pay rate so that it is between the original pay rate and the increased pay rate.

In some embodiments, the treatment engine 326 also may adjust a treatment based on information received from the effect evaluation engine 328 indicating whether a difference between an effect of an application of a treatment and an additional effect of an absence of the application of the treatment on the demand side and the supply side associated with the online system 102 is at least a threshold difference. For example, suppose that an application of a treatment (e.g., a higher delivery cost) had an effect corresponding to a first conversion rate and that an absence of the application of the treatment (i.e., an original delivery cost) had an additional effect corresponding to a second conversion rate, in which the second conversion rate is higher than the first conversion rate. In this example, if the treatment engine 326 receives information from the effect evaluation engine 328 indicating that a difference between the first conversion rate and the second conversion rate is at least a threshold difference, the treatment engine 326 may adjust the treatment by changing the delivery cost so that it is between the original delivery cost and the higher delivery cost. However, in the above example, if the information received by the treatment engine 326 indicates that the difference between the first conversion rate and the second conversion rate is not at least the threshold difference, the treatment engine 326 either may not adjust the treatment or it may adjust the treatment to an even higher delivery cost.

The online system 102 further includes the effect evaluation engine 328. The effect evaluation engine 328 measures an effect of an application of a treatment on the demand side and the supply side associated with the online system 102 based on a simulation of the application of the treatment on the demand side and the supply side associated with the online system 102, in which the effect is associated with one or more goals of the online system 102. In some embodiments, the effect evaluation engine 328 also may measure an additional effect of an absence of an application of a treatment on the demand side and the supply side associated with the online system 102 based on a simulation of the absence of the application of the treatment on the demand side and the supply side associated with the online system 102, in which the additional effect also is associated with one or more goals of the online system 102. In such embodiments, the effect evaluation engine 328 may measure the additional effect to establish a baseline with which the effect of the application of the treatment on the demand side and the supply side associated with the online system 102 is compared, allowing the effect of the treatment to be evaluated while minimizing the effects of other variables. An application of a treatment (or an absence of its application) may have an effect on a conversion rate, a probability that orders/batches are accepted for fulfillment by shoppers 208, a probability that orders are delivered late, a probability that orders are fulfilled accurately, a retention rate of customers 204 and/or shoppers 208, etc. The effect of an application of a treatment (or an absence of its application) may correspond to a value (e.g., an average or a total value), a rate, a ratio, or any other suitable measurement. For example, an application of a treatment (or an absence of its application) may have an effect on a rate at which orders are delivered on time (i.e., by an estimated delivery time and/or within a delivery window), a rate at which orders are fulfilled accurately, an average rating associated with shoppers 208, a conversion rate, a retention rate associated with customers 204 and/or shoppers 208, an average number of orders placed per day, a ratio of customers 204 to shoppers 208, etc. In some embodiments, once the effect evaluation engine 328 measures an effect of an application of a treatment (or an absence of its application), the effect evaluation engine 328 may store the measurement in the effect database 330, as further described below. In such embodiments, the measurement may be stored in association with various types of information (e.g., a time at which it was measured, information describing a simulation for which it was measured, etc.).

As described above, in some embodiments, the effect evaluation engine 328 also may determine whether an effect of an application of a treatment is at least a threshold effect. In such embodiments, the threshold effect may be predetermined by the online system 102 (e.g., based on one or more goals of the online system 102). For example, based on a goal of the online system 102 to grow by at least 10% per year, the online system 102 may determine that an average number of orders placed per day must increase by an average of 500 orders per day. In this example, once the effect evaluation engine 328 measures an effect of an application of a treatment on the increase in the average number of orders placed per day, the effect evaluation engine 328 may compare the measured effect to the threshold effect and determine whether the effect is at least the threshold effect based on the comparison.

In embodiments in which the effect evaluation engine 328 measures an effect of an application of a treatment and an additional effect of an absence of the application of the treatment on the demand side and the supply side associated with the online system 102, the effect evaluation engine 328 also may determine a difference between the effect and the additional effect and determine whether the difference is at least a threshold difference. In some embodiments, the effect evaluation engine 328 may determine the difference between the effect and the additional effect by performing a t-test. In such embodiments, the effect evaluation engine 328 may then determine whether the difference is at least a critical value for a particular confidence interval. For example, suppose that a goal of the online system 102 is to increase a retention rate for customers 204 by increasing an average rate at which orders are fulfilled on time and that the effect evaluation engine 328 measures an effect of an application of a treatment, which corresponds to an average rate at which orders are fulfilled on time. In this example, suppose also that the effect evaluation engine 328 measures an additional effect of an absence of the application of the treatment, which corresponds to an additional average rate at which orders are fulfilled on time. Continuing with this example, the effect evaluation engine 328 may determine a difference between the effect and the additional effect by performing a t-test. In this example, the effect evaluation engine 328 performs the t-test by calculating a t-value based on the effect and the additional effect and then determines whether the t-value is greater than a critical value, which indicates whether the t-value is greater than what could be attributable to chance. In the above example, if the t-value is greater than the critical value, the effect evaluation engine 328 may communicate this to the treatment application engine 332, which may then apply the treatment to a set of users of the online system 102, as further described below.

In some embodiments, the online system 102 further includes an effect database 330. The effect database 330 may store measurements of effects of applications of treatments (or of an absence of their applications, in various embodiments) on the demand side and the supply side associated with the online system 102 measured by the effect evaluation engine 328. A measurement may be stored in the effect database 330 in association with various types of information. For example, a measurement may be stored in association with a time at which it was measured by the effect evaluation engine 328. As an additional example, a measurement may be stored in association with information describing a simulation of an application of a treatment (or an absence of its application) for which the effect was measured, such as information describing the treatment, information describing a population of online system users included in the simulation, a time period associated with the simulation, etc.

In some embodiments, the online system 102 further includes a treatment application engine 332. The treatment application engine 332 may apply a treatment to a set of users of the online system 102. In various embodiments, the treatment application engine 332 may do so upon receiving information from the effect evaluation engine 328 indicating that an effect of an application of a treatment on the demand side and the supply side associated with the online system 102 is at least a threshold effect. In alternative embodiments, the treatment application engine 332 may do so upon receiving information from the effect evaluation engine 328 indicating that a difference between an effect of an application of a treatment and an additional effect of an absence of the application of the treatment on the demand side and the supply side associated with the online system 102 is at least a threshold difference.

The treatment application engine 332 may apply a treatment to a set of users of the online system 102 in various contexts. In some embodiments, the treatment application engine 332 may apply a treatment to a set of users of the online system 102 in the context of performing a test (e.g., an A/B test). The treatment application engine 332 may do so to verify the effect of the application of the treatment and/or the additional effect of the absence of the application of the treatment in a simulation environment. For example, the treatment application engine 332 may apply a treatment in the context of an A/B test, in which the treatment is applied to online system users included in a test group, but not to online system users in a control group. In this example, an effect of the treatment on the test group and an additional effect of the absence of the treatment on the control group are compared to each other and the online system 102 may then make various decisions based on the results (e.g., whether the test results were reliable, whether to enact new policies, heuristics, or constraints based on the test results, whether to continue testing the treatment, whether to retest the treatment, etc.).

In various embodiments, the treatment application engine 332 may apply a treatment to a set of users of the online system 102 in the context of enacting or applying a new policy, heuristic, or constraint. In such embodiments, the treatment application engine 332 may determine the policy, heuristic, or constraint based on information received from the effect evaluation engine 328. For example, upon receiving information from the effect evaluation engine 328 indicating that an effect of an application of a treatment on the demand side and the supply side associated with the online system 102 is at least a threshold effect, the treatment application engine 332 may determine a policy corresponding to the treatment (e.g., a new minimum pay rate) and apply the treatment to a population of online system users (e.g., users in a particular geographic location). As an additional example, upon receiving information from the effect evaluation engine 328 indicating that an effect of an application of a treatment on the demand side and the supply side associated with the online system 102 is at least a threshold effect, the treatment application engine 332 may determine a heuristic corresponding to the treatment (e.g., a new algorithm for batching orders) and apply the treatment to a population of online system users (e.g., users in multiple geographic locations). As yet another example, upon receiving information from the effect evaluation engine 328 indicating that a difference between an effect of an application of a treatment and an additional effect of the absence of the application of the treatment on the demand side and the supply side associated with the online system 102 is at least a threshold difference, the treatment application engine 332 may determine a constraint corresponding to the treatment. In this example, if the constraint corresponds to a maximum size of a delivery window, the treatment application engine 332 may then apply the treatment to all users of the online system 102.

### Customer Mobile Application

FIG. 4A is a diagram of the customer mobile application (CMA) 206, according to one or more embodiments. The CMA 206 includes an ordering interface 402, which provides an interactive interface which a customer 204 may use to browse through and select products and place an order. The CMA 206 also includes a system communication interface 404 which, among other functions, receives inventory information from the online system 102 and transmits order information to the system 102. The CMA 206 also includes a preferences management interface 406 which allows a customer 204 to manage basic information associated with his/her account, such as his/her home address and payment instruments. The preferences management interface 406 may also allow a customer 204 to manage other details such as his/her favorite or preferred warehouses 210, preferred delivery times, special instructions for delivery, and so on.

### Shopper Mobile Application

FIG. 4B is a diagram of the shopper mobile application (SMA) 212, according to one or more embodiments. The SMA 212 includes a barcode scanning module 420, which allows a shopper 208 to scan an item at a warehouse 210 (such as a can of soup on the shelf at a grocery store). The barcode scanning module 420 may also include an interface, which allows a shopper 208 to manually enter information describing an item (such as its serial number, SKU, quantity and/or weight) if a barcode is not available to be scanned. The SMA 212 also includes a basket manager 422, which maintains a running record of items collected by a shopper 208 for purchase at a warehouse 210. This running record of items is commonly known as a “basket.” In one or more embodiments, the barcode scanning module 420 transmits information describing each item (such as its cost, quantity, weight, etc.) to the basket manager 422, which updates its basket accordingly. The SMA 212 also includes a system communication interface 424, which interacts with the online system 102. For example, the system communication interface 424 receives an order from the online system 102 and transmits the contents of a basket of items to the online system 102. The SMA 212 also includes an image encoder 426 which encodes the contents of a basket into an image. For example, the image encoder 426 may encode a basket of goods (with an identification of each item) into a QR code, which may then be scanned by an employee of a warehouse 210 at check-out.

Simulating an Application of a Treatment on a Demand Side and a Supply Side Associated with an Online System

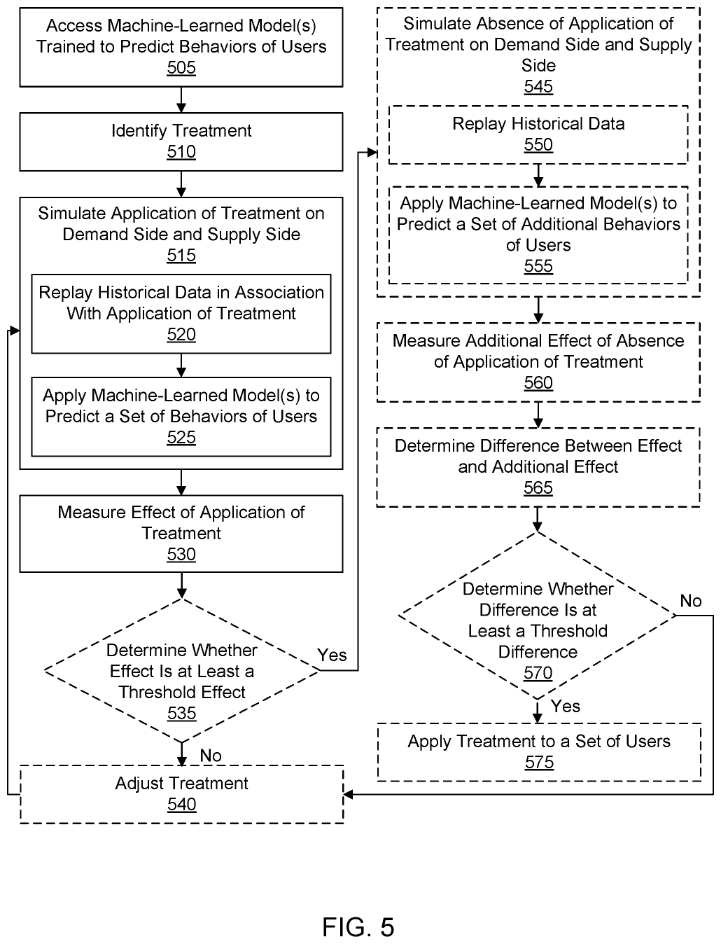

FIG. 5 is a flowchart of a method for simulating an application of a treatment on a demand side and a supply side associated with an online system 102, according to one or more embodiments. In various embodiments, the method includes different or additional steps than those described in conjunction with FIG. 5. Further, in some embodiments, the steps of the method may be performed in different orders than the order described in conjunction with FIG. 5. The method described in conjunction with FIG. 5 may be carried out by the online system 102 in various embodiments, while in other embodiments, the steps of the method are performed by any online system capable of retrieving items.

The online system 102 accesses 505 (e.g., using the simulation engine 324) one or more machine learning models (e.g., one or more machine learning user behavior models 322) trained to predict behaviors of users of the online system 102. A single machine learning model may be used to predict any number of behaviors for any number of users of the online system 102. The machine learning model(s) may be updated and adapted to receive any information that the online system 102 identifies (e.g., using the modeling engine 318) as an indicator of user behavior following retraining (e.g., with new training datasets 320). Furthermore, a machine learning model may be any machine learning model (e.g., a neural network, a boosted tree, a gradient-boosted tree, or a random forest model).

The online system 102 may train (e.g., using the modeling engine 318) the machine learning model(s) based on historical data (e.g., maintained in the training datasets 320), in which the historical data is associated with users of the online system 102 as well as the demand side and the supply side associated with the online system 102. The machine learning model(s) may be trained once the online system 102 receives the historical data (e.g., via one or more components of the online system 102, CMA 206, and/or the SMA 212). The historical data may relate a variety of different factors to interactions with the online system 102 by its users. For example, historical data associated with the demand side associated with the online system 102 may describe various interactions of a customer 204 with the online system 102 (e.g., via the CMA 206), such as a time at which the customer 204 accessed an ordering interface, whether the customer 204 placed an order, any promotions or offers presented to the customer 204, etc. In the above example, the historical data also may describe items the customer 204 browsed during the session, an amount of time the customer 204 browsed each item, an estimated delivery time, a size of a delivery window, and/or a delivery cost presented to the customer 204, whether the customer 204 included special instructions for an order, whether the customer 204 later reported a problem with an order, etc. As an additional example, historical data associated with the supply side associated with the online system 102 may describe various interactions of a shopper 208 with the online system 102 (e.g., via the SMA 212), such as a time at which an order or batch was transmitted to the shopper 208, whether the shopper 208 accepted or rejected the order/batch for fulfillment, a location associated with the shopper 208 when the shopper 208 accepted/rejected the order/batch for fulfillment, etc. In the above example, the historical data also may describe one or more warehouses 210 at which the order/batch was to be fulfilled, an amount of time elapsed between transmission and acceptance/rejection of the order/batch by the shopper 208, one or more delivery locations associated with the order/batch, one or more tip amounts associated with the order/batch, special instructions associated with the order/batch, information identifying the order/batch, etc.

In some embodiments, the machine learning model(s) accessed 505 by the online system 102 may be trained based on various features associated with the users of the online system 102 included among the historical data. For example, for online system users who are shoppers 208, the machine learning model(s) may be trained based on features including whether the shoppers 208 accepted or rejected orders or batches for fulfillment, dates, times of day, and/or days of the week during which they accepted/rejected orders/batches for fulfillment, pay rates and/or tip amounts for which they accepted/rejected orders/batches for fulfillment, etc. As an additional example, for online system users who are customers 204, the machine learning model(s) may be trained based on features including whether the customers 204 placed orders, dates, times of day, and/or days of the week during which they placed orders, etc. Features that are predictors of user behavior may be different for different users. For example, an estimated delivery time and a size of a delivery window may be the best predictors of whether customers 204 in urban areas are likely to place orders, whereas a delivery cost may be the best predictor of whether customers 204 in suburban areas are likely to place orders. For each online system user, the machine learning model(s) may weight these features differently, in which the weights are a result of a “learning” or a training process on the historical data. Once trained, the machine learning model(s) may receive inputs corresponding to features associated with online system users used to train the machine learning model(s) and output predicted behaviors of the online system users based on the inputs.

In some embodiments, behaviors of users of the online system 102 predicted by the machine learning model(s) accessed 505 by the online system 102 are associated with the supply side and/or the demand side associated with the online system 102. Examples of user behaviors associated with the supply side associated with the online system 102 that may be predicted by the machine learning model(s) include whether a shopper 208 will accept an order/batch for fulfillment for a given time of day, day of the week, pay rate, tip amount, estimated delivery time, delivery window, warehouse 210 at which the order/batch is to be fulfilled, delivery location associated with the order/batch, order/batch size, etc. Additional examples of user behaviors associated with the supply side associated with the online system 102 that may be predicted by the machine learning model(s) include whether a shopper 208 will fulfill an order by an estimated delivery time and/or within a delivery window, whether a shopper 208 will take a particular route to fulfill an order/batch, whether a shopper 208 will fulfill an order accurately, etc. Examples of user behaviors associated with the demand side associated with the online system 102 that may be predicted by the machine learning model(s) include whether a customer 204 will place an order for a given time of day, day of the week, delivery cost, estimated delivery time, delivery window size, etc. Additional examples of user behaviors associated with the demand side associated with the online system 102 that may be predicted by the machine learning model(s) include whether a customer 204 will place an order that includes at least a threshold number of items and/or a certain type of item, whether a customer 204 will place an order with a particular retailer, whether a customer 204 will include special instructions in an order, etc.

In some embodiments, the machine learning model(s) accessed 505 by the online system 102 may predict behaviors of online system users based on one or more conversion and/or cost curves generated by the machine learning model(s) (e.g., from the training datasets 320). A conversion curve may describe a likelihood that one or more users of the online system 102 will perform an action corresponding to a conversion given one or more variables (e.g., a delivery cost, an estimated delivery time, a delivery window size, a time of day, a day of the week, etc.). Similarly, a cost curve may describe a cost of fulfilling an order given one or more variables (e.g., whether the order is included in a batch, a number of additional orders included in a batch in which the order is included, a retailer with which the order was placed, a number of warehouses 210 at which the order may be fulfilled, a delivery location associated with the order, etc.). In some embodiments, the cost of fulfilling an order described by a cost curve may correspond to a delivery cost that may be charged to a customer 204, while in other embodiments, the cost of fulfilling an order may correspond to and/or include other costs associated with fulfilling an order (e.g., overhead costs incurred by the online system 102). A conversion curve and/or a cost curve may be plotted for multiple dimensions, in which each dimension corresponds to a different variable.

The machine learning model(s) accessed 505 by the online system 102 may generate different conversion and/or cost curves for different groups of online system users (e.g., groups of users that have at least a threshold measure of similarity to each other). For example, the machine learning model(s) may generate different conversion curves and cost curves for online system users associated with different geographic areas. As an additional example, the machine learning model(s) may generate a conversion curve for online system users whose likelihood of placing an order is highly dependent on a size of a delivery window, but only slightly dependent on an amount of a delivery cost. In the above example, the machine learning model(s) may generate a different conversion curve for online system users whose likelihood of placing an order is highly dependent on an amount of a delivery cost, but only slightly dependent on a size of a delivery window. In embodiments in which the online system 102 accesses (step 505) multiple machine learning models, different machine learning models may generate different conversion and/or cost curves.

In some embodiments, a prediction output by the machine learning model(s) accessed 505 by the online system 102 includes a confidence score. A confidence score may be an error or uncertainty score of a predicted user behavior and may be calculated using any standard statistical error measurement. In some embodiments, confidence scores are based in part on whether predictions were accurate for previous types of user behaviors predicted by the machine learning model(s) (e.g., when simulating 545 an absence of an application of a treatment, as further described below), such that types of predicted behaviors that were more accurate have higher confidence scores than types of predicted behaviors that were less accurate. In various embodiments, confidence scores associated with predicted user behaviors are based in part on the age of the historical data used to train the machine learning model(s) that made the predictions, such that the confidence scores are inversely proportional to the age of the historical data.

In embodiments in which the online system 102 accesses (step 505) multiple machine learning models, different machine learning models may predict different types of behaviors and/or behaviors for different users of the online system 102. For example, one machine learning model may predict a likelihood that a shopper 208 will accept an order or a batch of orders for fulfillment while another machine learning model may predict an amount of time the shopper 208 will take to fulfill the order/batch. As an additional example, one machine learning model may predict user behaviors for online system users in one geographic area while another machine learning model may predict user behaviors for online system users in another geographic area.

In embodiments in which the online system 102 accesses (step 505) multiple machine learning models, the output of one machine learning model may be used by the online system 102 to determine an input for another machine learning model (e.g., when performing branched simulations or simulations for discrete events, as described below). For example, if a first machine learning model outputs predictions about whether various shoppers 208 will accept orders/batches for fulfillment and confidence scores associated with the predictions, the online system 102 may provide the predictions as inputs to a second machine learning model. In this example, the second machine learning model then outputs predictions about whether the shoppers 208 will fulfill the orders/batches by their corresponding estimated delivery times and/or within their delivery windows and confidence scores associated with the predictions.

The online system 102 then identifies 510 (e.g., using the treatment engine 326) a treatment for achieving one or more goals of the online system 102. Goals of the online system 102 may include maximizing growth, minimizing cost to its users, or any other suitable goal. A treatment may correspond to any potential change associated with the online system 102, such as a change to a delivery cost, an estimated delivery time, a size of a delivery window, an algorithm for batching orders, a pay rate, accepted payment instruments, default tip amounts, an algorithm for generating routes for fulfilling orders/batches, a reward/loyalty club membership, or any other suitable change. For example, a treatment may correspond to a larger or smaller delivery window, a longer or shorter estimated delivery time from a time when an order is placed, a higher or lower delivery cost, a higher or lower pay rate, or a higher or lower default tip amount. In some embodiments, the online system 102 may identify (step 510) multiple treatments. For example, the online system 102 may identify (step 510) multiple treatments, such as a combination of a higher delivery cost, a smaller delivery window, and a shorter estimated delivery time from a time when an order is placed. In various embodiments, the online system 102 also or alternatively may identify (step 510) multiple versions of a treatment. For example, the online system 102 may identify (step 510) multiple versions of a treatment, such as different versions of an algorithm that each includes a different number of orders together in a batch.

The online system 102 then simulates 515 (e.g., using the simulation engine 324) an application of the treatment on the demand side and the supply side associated with the online system 102. The online system 102 may do so based on historical data associated with online system users and a set of behaviors predicted for the users, in which the historical data is associated with the demand side and the supply side associated with the online system 102. To simulate 515 the application of the treatment, the online system 102 replays 520 (e.g., using the simulation engine 324) the historical data in association with application of the treatment and applies 525 (e.g., using the simulation engine 324) the machine learning model(s) to predict the set of behaviors of the users while replaying 520 the historical data in association with the application of the treatment. In various embodiments, the online system 102 also may simulate 515 the application of the treatment on the demand side and the supply side associated with the online system 102 based on current data associated with online system users and a set of behaviors predicted for the users, in which the current data is associated with the demand side and the supply side associated with the online system 102. In such embodiments, the online system 102 may do so by applying the treatment to the current data as it is received (e.g., via various components of the online system 102, the CMA 206, and/or the SMA 212) and applying 525 the machine learning model(s) to predict the set of behaviors of the users of the online system 102 while applying the treatment to the current data.

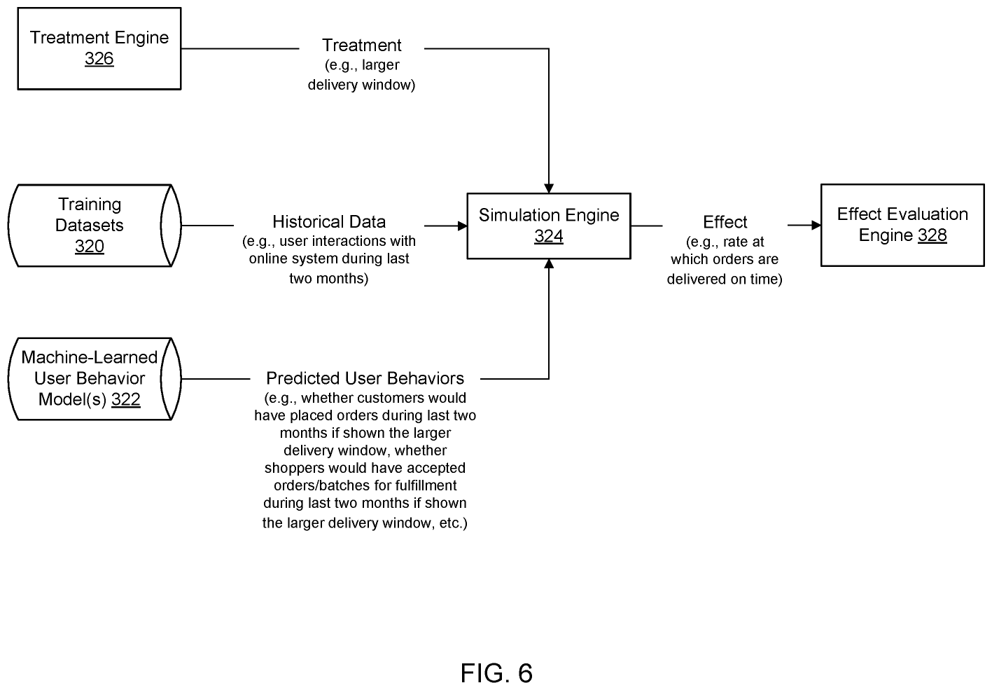

The online system 102 may simulate 515 the application of the treatment on the demand side and the supply side associated with the online system 102 for a particular population of users of the online system 102 (e.g., users in a particular geographic location) for a particular time period, etc. To do so, the online system 102 may replay 520 the historical data (or play the current data, in various embodiments) for the corresponding population, time period, etc. while applying the treatment and apply 525 the machine learning model(s) to predict the set of behaviors of the users of the online system 102 while replaying 520 the historical data in association with application of the treatment. An example is shown in FIG. 6, which is a conceptual diagram of a method for simulating 515 an application of a treatment on a demand side and a supply side associated with an online system 102, according to one or more embodiments. In this example, if a treatment corresponds to a larger delivery window, the online system 102 may apply the treatment while replaying 520 the historical data for a time period of two months, such that the online system 102 simulates 515 an environment in which the larger delivery window was shown to customers 204 and shoppers 208 who interacted with the online system 102 during the two months. Continuing with this example, the online system 102 applies 525 the machine learning model(s) to predict a set of behaviors of the users of the online system 102, such as whether the customers 204 would have placed orders during the two months if they were shown the larger delivery window. In the above example, the machine learning model(s) also may predict another set of behaviors of the users of the online system 102, such as whether the shoppers 208 would have accepted orders/batches for fulfillment based on orders that the machine learning model(s) predicted the customers 204 would have placed if the shoppers 208 were shown the larger delivery window. In this example, inputs to the machine learning model(s) may include information identifying the customers 204 and shoppers 208, the larger delivery window, the two-month time period, information included among the replayed historical data (e.g., delivery costs and estimated delivery times shown to the customers 204, warehouses 210 at which the orders were fulfilled, pay rates, etc.), or any other suitable features. In the above example, one or more of the predictions also may be associated with a confidence score indicating the error or uncertainty score of the predicted user behavior. As shown in this example, the application of the treatment may have a measurable effect, such as an effect on a rate at which orders are delivered on time, as further described below. In some embodiments, the online system 102 may simulate (step 515) the application of multiple treatments (e.g., changes to an estimated delivery time and a delivery window) and/or multiple versions of the treatment (e.g., delivery windows that are 60 minutes, 75 minutes, 90 minutes, etc.).

In some embodiments, the online system 102 also may apply various constraints, heuristics, and/or policies when replaying 520 the historical data (or when playing the current data, in various embodiments) in association with application of the treatment. Constraints, heuristics, and/or policies applied by the online system 102 may be associated with various regulations, a size of a delivery window, an estimated delivery time, a delivery cost, a pay rate, a conversion rate, a probability that orders are batched, a probability that orders/batches are accepted for fulfillment by shoppers 208, a probability that orders are delivered late, a retention rate of customers 204 and/or shoppers 208, etc. Examples of constraints include a maximum rate at which orders may be delivered late (e.g., after their estimated delivery times and/or outside their delivery windows), a maximum estimated delivery time after an order is placed, a minimum and/or maximum pay rate, a minimum and/or maximum delivery cost, membership requirements associated with shoppers 208 fulfilling orders with certain retailers, maximum cargo spaces associated with shoppers 208, etc. Examples of heuristics include an algorithm for batching orders (e.g., based on when they are received, based on a maximum number of orders included in a batch, etc.) and an algorithm for generating routes for fulfilling orders/batches (e.g., based on travel times, tolls, warehouse 210 and delivery locations, items included in each order, etc.). Examples of policies include a maximum number of hours a shopper 208 may work per day, a minimum age of a shopper 208 allowed to fulfill orders that include certain types of items (e.g., alcohol and tobacco), etc. For example, if multiple versions of a treatment correspond to different sizes of delivery windows that are 30 minutes apart, the online system 102 may replay 520 the historical data in association with application of each version of the treatment and a constraint corresponding to a maximum delivery window size of three hours. In the above example, the online system 102 also may replay 520 the historical data in association with application of a policy corresponding to a minimum age of a shopper 208 allowed to fulfill orders that include alcohol and tobacco and a heuristic corresponding to an algorithm for batching orders based on when orders are received.

The online system 102 may simulate 515 the application of the treatment on the demand side and the supply side associated with the online system 102 at various levels. In various embodiments, the online system 102 may simulate 515 the application of the treatment on the demand side and the supply side associated with the online system 102 in aggregate. For example, the online system 102 may simulate 515 the application of the treatment on the demand side and the supply side associated with the online system 102 for all users of the online system 102 who interacted with the online system 102 within a time period associated with historical data that is replayed 520 by the online system 102, such that the online system 102 may not account for the order in which each event occurred based on the historical data. In some embodiments, the online system 102 may simulate 515 the application of the treatment on the demand side and the supply side associated with the online system 102 by performing branched simulations. For example, the online system 102 may simulate 515 the application of the treatment on the demand side and the supply side associated with the online system 102 for users of the online system 102 who interacted with the online system 102 within each hour of a time period associated with the historical data that is replayed 520 by the online system 102. In this example, the outcome of the simulation for each hour (e.g., orders placed, orders/batches accepted, etc.) serves as the seed for the simulation of the following hour until the historical data for the entire time period is replayed 520 in association with application of the treatment. In various embodiments, the online system 102 may simulate 515 the application of the treatment on the demand side and the supply side associated with the online system 102 for discrete events. For example, the online system 102 may simulate 515 the application of the treatment on the demand side and the supply side associated with the online system 102 for each event within a time period associated with the historical data that is replayed 520 by the online system 102. In this example, the outcome of the simulation for each event (e.g., whether a particular customer 204 places an order, whether a particular shopper 208 accepts an order/batch for fulfillment, etc.) serves as the seed for the simulation of the following event until the historical data for the entire time period is replayed 520 in association with application of the treatment.

Referring back to FIG. 5, the online system 102 then measures 530 (e.g., using the effect evaluation engine 328) an effect of the application of the treatment on the demand side and the supply side associated with the online system 102 based on the simulation of the application of the treatment, in which the effect is associated with the goal(s) of the online system 102. The application of the treatment may have an effect on a conversion rate, a probability that orders/batches are accepted for fulfillment by shoppers 208, a probability that orders are delivered late, a probability that orders are fulfilled accurately, a retention rate of customers 204 and/or shoppers 208, etc. The effect of the application of the treatment may correspond to a value (e.g., an average or a total value), a rate, a ratio, or any other suitable measurement. For example, the application of the treatment may have an effect on a rate at which orders are delivered on time (i.e., by an estimated delivery time and/or within a delivery window), a rate at which orders are fulfilled accurately, an average rating associated with shoppers 208, a conversion rate, a retention rate associated with customers 204 and/or shoppers 208, an average number of orders placed per day, a ratio of customers 204 to shoppers 208, etc. In some embodiments, once the online system 102 measures 530 the effect of the application of the treatment, the online system 102 may store (e.g., using the effect evaluation engine 328) the measurement (e.g., in the effect database 330). In such embodiments, the measurement may be stored in association with various types of information (e.g., a time at which it was measured 530, information describing the simulation of the application of the treatment for which it was measured 530, etc.).

In some embodiments, the online system 102 may then determine 535 (e.g., using the effect evaluation engine 328) whether the effect of the application of the treatment is at least a threshold effect. In such embodiments, the threshold effect may be predetermined by the online system 102 (e.g., based on the goal(s) of the online system 102). For example, based on a goal of the online system 102 to grow by at least 10% per year, the online system 102 may determine that an average number of orders placed per day must increase by an average of 500 orders per day. In this example, once the online system 102 measures 530 the effect of the application of the treatment on the increase in the average number of orders placed per day, the online system 102 may compare the measured effect to the threshold effect and determine 535 whether the effect is at least the threshold effect based on the comparison.

In various embodiments, the online system 102 may adjust 540 (e.g., using the treatment engine 326) the treatment based on whether the online system 102 determines 535 that the effect of the application of the treatment is at least the threshold effect. For example, suppose that the treatment corresponds to an increased pay rate for shoppers 208 and that its application had an effect corresponding to a decrease in a rate at which orders were delivered late (i.e., after an estimated delivery time and/or outside a delivery window) that is less than a threshold decrease in the rate. In this example, the online system 102 may adjust 540 the treatment by increasing the pay rate for shoppers 208 to an even higher rate. However, in the above example, if the treatment had an effect corresponding to a decrease in the rate at which orders were delivered late that is at least the threshold decrease in the rate, the online system 102 either may not adjust 540 the treatment or it may adjust 540 the treatment by changing the pay rate so that it is between the original pay rate and the increased pay rate. In embodiments in which the online system 102 adjusts 540 the treatment, one or more steps of the flowchart may be repeated (e.g., by proceeding back to step 515) for the adjusted treatment.

In some embodiments, the online system 102 may then simulate 545 (e.g., using the simulation engine 324) an absence of the application of the treatment on the demand side and the supply side associated with the online system 102. In such embodiments, the online system 102 may do so based on the historical data associated with the online system users and a set of behaviors predicted for the users. To simulate 545 the absence of the application of the treatment, the online system 102 replays 550 (e.g., using the simulation engine 324) the historical data and applies 555 (e.g., using the simulation engine 324) the machine learning model(s) to predict the set of behaviors of the users while replaying 550 the historical data. In embodiments in which the online system 102 simulates 515 the application of the treatment on the demand side and the supply side associated with the online system 102 based on current data, the online system 102 also may simulate 545 the absence of the application of the treatment on the demand side and the supply side associated with the online system 102 based on the current data and a set of behaviors predicted for the users. In such embodiments, the online system 102 may do so by playing the current data as it is received (e.g., via various components of the online system 102, the CMA 206, and/or the SMA 212) and applying 555 the machine learning model(s) to predict the set of behaviors of the users of the online system 102 while playing the current data.

In embodiments in which the online system 102 simulates 515 the application of the treatment on the demand side and the supply side associated with the online system 102 for a particular population of users of the online system 102, for a particular time period, etc., the online system 102 may do so as well when simulating 545 the absence of the application of the treatment. In such embodiments, the online system 102 may do so by replaying 550 the historical data (or playing the current data, in various embodiments) for the corresponding population, time period, etc. and by applying 555 the machine learning model(s) to predict the set of behaviors of the users of the online system 102 while replaying 550 the historical data. For example, if the treatment corresponds to a larger delivery window, the online system 102 may not apply the treatment while replaying 550 the historical data for a time period of two months, such that the online system 102 simulates 545 an environment in which the original delivery window was shown to customers 204 and shoppers 208 who interacted with the online system 102 during the two months. Continuing with this example, the online system 102 applies 555 the machine learning model(s) to predict a set of behaviors of users of the online system 102, such as whether the customers 204 would have placed orders during the two months if they were shown the original delivery window. In the above example, the machine learning model(s) also may predict another set of behaviors of users of the online system 102, such as whether the shoppers 208 would have accepted orders/batches for fulfillment based on orders that the machine learning model(s) predicted the customers 204 would have placed if the shoppers 208 were shown the original delivery window. In this example, inputs to the machine learning model(s) may include information identifying the customers 204 and shoppers 208, the original delivery window, the two-month time period, information included among the replayed historical data (e.g., delivery costs and estimated delivery times shown to the customers 204, warehouses 210 at which the orders were fulfilled, pay rates, etc.), or any other suitable features. In the above example, one or more of the predictions also may be associated with a confidence score indicating the error or uncertainty score of the predicted user behavior. In some embodiments, the online system 102 may simulate 545 the absence of the application of multiple treatments (e.g., changes to an estimated delivery time and a delivery window) and/or the absence of the application of multiple versions of the treatment (e.g., delivery windows that are 60 minutes, 75 minutes, 90 minutes, etc.).

In embodiments in which the online system 102 simulates 545 the absence of the application of the treatment on the demand side and the supply side associated with the online system 102, the online system 102 may do so in a manner analogous to that described above in conjunction with simulating 515 the application of the treatment. In such embodiments, when simulating 545 the absence of the application of the treatment on the demand side and the supply side associated with the online system 102, the online system 102 also may apply various constraints, heuristics, and/or policies when replaying 550 the historical data (or when playing current data, in various embodiments). Furthermore, the online system 102 also may simulate 545 the absence of the application of the treatment on the demand side and the supply side associated with the online system 102 at various levels (e.g., in aggregate, by performing branched simulations, for discrete events, etc.).

In some embodiments, the online system 102 may then measure 560 (e.g., using the effect evaluation engine 328) an additional effect of the absence of the application of the treatment on the demand side and the supply side associated with the online system 102 based on the simulation of the absence of the application of the treatment, in which the additional effect is associated with the goal(s) of the online system 102. In such embodiments, the online system 102 may do so to establish a baseline with which the effect of the treatment on the demand side and the supply side associated with the online system 102 is compared, allowing the effect of the treatment to be evaluated while minimizing the effects of other variables. Similar to the application of the treatment, the absence of the application of the treatment may have an effect on a conversion rate, a probability that orders/batches are accepted for fulfillment by shoppers 208, a probability that orders are delivered late, a probability that orders are fulfilled accurately, a retention rate of customers 204 and/or shoppers 208, etc. Also similar to the effect of the application of the treatment, the effect of the absence of the application of the treatment may correspond to a value (e.g., an average or a total value), a rate, a ratio, or any other suitable measurement. For example, the absence of the application of the treatment may have an effect on a rate at which orders are delivered on time (i.e., by an estimated delivery time and/or within a delivery window), a rate at which orders are fulfilled accurately, an average rating associated with shoppers 208, a conversion rate, a retention rate associated with customers 204 and/or shoppers 208, an average number of orders placed per day, a ratio of customers 204 to shoppers 208, etc. In some embodiments, once the online system 102 measures 560 the additional effect of the absence of the application of the treatment, the online system 102 may store (e.g., using the effect evaluation engine 328) the measurement (e.g., in the effect database 330). In such embodiments, the measurement may be stored in association with various types of information (e.g., a time at which it was measured 560, information describing the simulation of the absence of the application of the treatment for which it was measured 560, etc.).

In embodiments in which the online system 102 measures 530 the effect of the application of the treatment and also measures 560 the additional effect of the absence of the application of the treatment, the online system 102 also may determine 565 (e.g., using the effect evaluation engine 328) a difference between the effect and the additional effect. In such embodiments, the online system 102 also may then determine 570 (e.g., using the effect evaluation engine 328) whether the difference is at least a threshold difference. In some embodiments, the online system 102 may determine 565 the difference between the effect and the additional effect by performing a t-test. In such embodiments, the online system 102 may then determine 570 whether the difference is at least a critical value for a particular confidence interval. For example, suppose that a goal of the online system 102 is to increase a retention rate for customers 204 by increasing an average rate at which orders are fulfilled on time and that the online system 102 measures 530 the effect of the application of the treatment, which corresponds to an average rate at which orders are fulfilled on time. In this example, suppose also that the online system 102 measures 560 the additional effect of the absence of the application of the treatment, which corresponds to an additional average rate at which orders are fulfilled on time. Continuing with this example, the online system 102 may determine 565 a difference between the effect and the additional effect by performing a t-test. In this example, the online system 102 may perform the t-test by calculating a t-value based on the effect and the additional effect and then determines 570 whether the t-value is greater than a critical value, which indicates whether the t-value is greater than what could be attributable to chance. In the above example, if the t-value is greater than the critical value, the online system 102 may then apply 575 the treatment to a set of users of the online system 102, as further described below.

In some embodiments, the online system 102 may adjust 540 (e.g., using the treatment engine 326) the treatment based on whether the online system 102 determines 570 the difference between the effect of the application of the treatment and the additional effect of the absence of the application of the treatment on the demand side and the supply side associated with the online system 102 is at least the threshold difference. For example, suppose that the application of the treatment (e.g., a higher delivery cost) had an effect corresponding to a first conversion rate and that an absence of the application of the treatment (i.e., an original delivery cost) had an additional effect corresponding to a second conversion rate, in which the second conversion rate is higher than the first conversion rate. In this example, if the online system 102 determines 570 that the difference between the first conversion rate and the second conversion rate is at least a threshold difference, the online system 102 may adjust 540 the treatment by changing the delivery cost so that it is between the original delivery cost and the higher delivery cost. However, in the above example, if the online system 102 determines 570 that the difference between the first conversion rate and the second conversion rate is not at least the threshold difference, the online system 102 either may not adjust 540 the treatment or it may adjust 540 the treatment to an even higher delivery cost.

In some embodiments, the online system 102 may apply 575 (e.g., using the treatment application engine 332) the treatment to a set of users of the online system 102. In various embodiments, the online system 102 may apply 575 the treatment to the set of users upon determining 535 that the effect of the application of the treatment on the demand side and the supply side associated with the online system 102 is at least the threshold effect. In alternative embodiments, the online system 102 may apply 575 the treatment to the set of users upon determining 570 that the difference between the effect of the application of the treatment and the additional effect of the absence of the application of the treatment on the demand side and the supply side associated with the online system 102 is at least the threshold difference.

The online system 102 may apply 575 the treatment to the set of users of the online system 102 in various contexts. In some embodiments, the online system 102 may apply 575 the treatment to the set of users of the online system 102 in the context of performing a test (e.g., an A/B test). The online system 102 may do so to verify the effect of the application of the treatment and/or the additional effect of the absence of the application of the treatment in a simulation environment. For example, the online system 102 may apply 575 the treatment in the context of an A/B test, in which the treatment is applied 575 to online system users included in a test group, but not to online system users in a control group. In this example, an effect of the treatment on the test group and an additional effect of the absence of the treatment on the control group are compared to each other and the online system 102 may then make various decisions based on the results (e.g., whether the test results were reliable, whether to enact new policies, heuristics, or constraints based on the test results, whether to continue testing the treatment, whether to retest the treatment, etc.).

In various embodiments, the online system 102 may apply 575 the treatment to the set of users of the online system 102 in the context of enacting or applying a new policy, heuristic, or constraint. In such embodiments, the online system 102 may determine (e.g., using the treatment application engine 332) the policy, heuristic, or constraint based on whether the online system 102 determines 535 that the effect of the application of the treatment is at least the threshold effect or based on whether the online system 102 determines 570 that the difference between the effect and the additional effect is at least the threshold difference. For example, upon determining 535 that the effect of the application of the treatment on the demand side and the supply side associated with the online system 102 is at least the threshold effect, the online system 102 may determine a policy corresponding to the treatment (e.g., a new minimum pay rate) and apply 575 the treatment to a population of online system users (e.g., users in a particular geographic location). As an additional example, upon determining 535 that the effect of the application of the treatment on the demand side and the supply side associated with the online system 102 is at least the threshold effect, the online system 102 may determine a heuristic corresponding to the treatment (e.g., a new algorithm for batching orders) and apply 575 the treatment to a population of online system users (e.g., users in multiple geographic locations). As yet another example, upon determining 570 that the difference between the effect of the application of the treatment and the additional effect of the absence of the application of the treatment on the demand side and the supply side associated with the online system 102 is at least the threshold difference, the online system 102 may determine a constraint corresponding to the treatment. In this example, if the constraint corresponds to a maximum size of a delivery window, the online system 102 may then apply 575 the treatment to all users of the online system 102.

### Additional Considerations

The foregoing description of the embodiments of the invention has been presented for the purpose of illustration; it is not intended to be exhaustive or to limit the invention to the precise forms disclosed. Many modifications and variations are possible in light of the above disclosure.

Some portions of this description describe the embodiments of the invention in terms of algorithms and symbolic representations of operations on information. These algorithmic descriptions and representations are commonly used in the data processing arts to convey the substance of their work effectively to others. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one or more embodiments, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a computing device selectively activated or reconfigured by a computer program stored in the computer. Such a computer program may be stored in a tangible computer readable storage medium, which include any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
accessing a machine learning model that is trained to predict behaviors of a plurality of users of an online system, wherein the machine learning model is trained by:
receiving historical data associated with the plurality of users of the online system, wherein the historical data is associated with a demand side and a supply side associated with the online system, and
training the machine learning model based at least in part on the historical data associated with the plurality of users;
identifying a treatment for achieving a goal of the online system;
simulating an application of the treatment on the demand side and the supply side associated with the online system based at least in part on the historical data and a set of behaviors predicted for the plurality of users, wherein simulating the application of the treatment comprises:
replaying the historical data in association with the application of the treatment, and
applying the machine learning model to predict the set of behaviors for the plurality of users while replaying the historical data in association with the application of the treatment; and
measuring an effect of the application of the treatment on the demand side and the supply side associated with the online system based at least in part on simulating the application of the treatment on the demand side and the supply side associated with the online system, wherein the effect is associated with the goal of the online system.

2. The method of claim 1, further comprising:
determining that the effect of the application of the treatment on the demand side and the supply side associated with the online system is at least a threshold effect;
responsive to determining that the effect of the application of the treatment on the demand side and the supply side associated with the online system is at least the threshold effect, simulating an absence of the application of the treatment on the demand side and the supply side associated with the online system based at least in part on the historical data and an additional set of behaviors predicted for the plurality of users, wherein simulating the absence of the application of the treatment comprises:
replaying the historical data, and
applying the machine learning model to predict the set of additional behaviors for the plurality of users while replaying the historical data;
measuring an additional effect of the absence of the application of the treatment on the demand side and the supply side associated with the online system based at least in part on simulating the absence of the application of the treatment on the demand side and the supply side associated with the online system, wherein the additional effect is associated with the goal of the online system; and
determining a difference between the effect and the additional effect.

3. The method of claim 2, further comprising:
determining that the difference between the effect and the additional effect is at least a threshold difference; and
responsive to determining that the difference between the effect and the additional effect is at least the threshold difference, applying the treatment to a set of users of the online system.

4. The method of claim 2, further comprising:
determining, based at least in part on the difference between the effect and the additional effect, one or more of: a policy, a heuristic, and a constraint.

5. The method of claim 2, wherein determining the difference between the effect and the additional effect comprises:
performing a t-test based at least in part on the effect and the additional effect.

6. The method of claim 1, further comprising:
determining that the effect of the application of the treatment on the demand side and the supply side associated with the online system is at least a threshold effect; and
responsive to determining that the effect of the application of the treatment on the demand side and the supply side associated with the online system is at least the threshold effect, applying the treatment to a set of users of the online system.

7. The method of claim 1, wherein the treatment affects one or more of: a size of a delivery window, an estimated delivery time, a delivery cost, a pay rate, and a probability of batching a plurality of orders.

8. The method of claim 1, wherein the machine learning model predicts a likelihood that a user of the online system will perform an action selected from the group consisting of: placing an order and accepting a batch of orders for fulfillment.

9. The method of claim 8, wherein an input to the machine learning model comprises one or more of: a size of a delivery window, an estimated delivery time, a delivery cost, and a pay rate.

10. The method of claim 1, wherein simulating the application of the treatment on the demand side and the supply side associated with the online system is further based at least in part on one or more of a policy and a constraint associated with one or more selected from the group consisting of: a set of regulations, a size of a delivery window, an estimated delivery time, a delivery cost, a pay rate, a conversion rate, a probability of batching a plurality of orders, a probability of acceptance of one or more orders for fulfillment by a user of the online system, a probability that a delivery of an order is late, and a retention rate of users of the online system.

11. A computer program product comprising a non-transitory computer readable storage medium having instructions encoded thereon that, when executed by a processor, cause the processor to:
access a machine learning model that is trained to predict behaviors of a plurality of users of an online system, wherein the machine learning model is trained by:
receiving historical data associated with the plurality of users of the online system, wherein the historical data is associated with a demand side and a supply side associated with the online system, and
training the machine learning model based at least in part on the historical data associated with the plurality of users;
identify a treatment for achieving a goal of the online system;
simulate an application of the treatment on the demand side and the supply side associated with the online system based at least in part on the historical data and a set of behaviors predicted for the plurality of users, wherein simulate the application of the treatment comprises:
replay the historical data in association with the application of the treatment, and
apply the machine learning model to predict the set of behaviors for the plurality of users while replaying the historical data in association with the application of the treatment; and
measure an effect of the application of the treatment on the demand side and the supply side associated with the online system based at least in part on simulating the application of the treatment on the demand side and the supply side associated with the online system, wherein the effect is associated with the goal of the online system.

12. The computer program product of claim 11, wherein the computer-readable storage medium further has instructions encoded thereon that, when executed by the processor, cause the processor to:
determine that the effect of the application of the treatment on the demand side and the supply side associated with the online system is at least a threshold effect;
responsive to determining that the effect of the application of the treatment on the demand side and the supply side associated with the online system is at least the threshold effect, simulate an absence of the application of the treatment on the demand side and the supply side associated with the online system based at least in part on the historical data and an additional set of behaviors predicted for the plurality of users, wherein simulate the absence of the application of the treatment comprises:
replay the historical data, and
apply the machine learning model to predict the set of additional behaviors for the plurality of users while replaying the historical data;
measure an additional effect of the absence of the application of the treatment on the demand side and the supply side associated with the online system based at least in part on simulating the absence of the application of the treatment on the demand side and the supply side associated with the online system, wherein the additional effect is associated with the goal of the online system; and
determine a difference between the effect and the additional effect.

13. The computer program product of claim 12, wherein the computer-readable storage medium further has instructions encoded thereon that, when executed by the processor, cause the processor to:
determine that the difference between the effect and the additional effect is at least a threshold difference; and
responsive to determining that the difference between the effect and the additional effect is at least the threshold difference, apply the treatment to a set of users of the online system.

14. The computer program product of claim 12, wherein the computer-readable storage medium further has instructions encoded thereon that, when executed by the processor, cause the processor to:
determine, based at least in part on the difference between the effect and the additional effect, one or more of: a policy, a heuristic, and a constraint.

15. The computer program product of claim 12, wherein determine the difference between the effect and the additional effect comprises:
perform a t-test based at least in part on the effect and the additional effect.

16. The computer program product of claim 11, wherein the computer-readable storage medium further has instructions encoded thereon that, when executed by the processor, cause the processor to:
determine that the effect of the application of the treatment on the demand side and the supply side associated with the online system is at least a threshold effect; and
responsive to determining that the effect of the application of the treatment on the demand side and the supply side associated with the online system is at least the threshold effect, apply the treatment to a set of users of the online system.

17. The computer program product of claim 11, wherein the treatment affects one or more of: a size of a delivery window, an estimated delivery time, a delivery cost, a pay rate, and a probability of batching a plurality of orders.

18. The computer program product of claim 11, wherein the machine learning model predicts a likelihood that a user of the online system will perform an action selected from the group consisting of: placing an order and accepting a batch of orders for fulfillment.

19. The computer program product of claim 18, wherein an input to the machine learning model comprises one or more of: a size of a delivery window, an estimated delivery time, a delivery cost, and a pay rate.

20. A computer system comprising:
a processor; and
a non-transitory computer readable storage medium storing instructions that, when executed by the processor, perform actions comprising:
accessing a machine learning model that is trained to predict behaviors of a plurality of users of an online system, wherein the machine learning model is trained by:
receiving historical data associated with the plurality of users of the online system, wherein the historical data is associated with a demand side and a supply side associated with the online system, and
training the machine learning model based at least in part on the historical data associated with the plurality of users;
identifying a treatment for achieving a goal of the online system;
simulating an application of the treatment on the demand side and the supply side associated with the online system based at least in part on the historical data and a set of behaviors predicted for the plurality of users, wherein simulating the application of the treatment comprises:
replaying the historical data in association with the application of the treatment, and
applying the machine learning model to predict the set of behaviors for the plurality of users while replaying the historical data in association with the application of the treatment; and
measuring an effect of the application of the treatment on the demand side and the supply side associated with the online system based at least in part on simulating the application of the treatment on the demand side and the supply side associated with the online system, wherein the effect is associated with the goal of the online system.
